(19) United States
(12) Patent Application Publication
(10) Pub. No.: US 2025/0167885 A1
(43) Pub. Date: May 22, 2025

(54) OPTICAL COMMUNICATION SYSTEM, MASTER STATION DEVICE, SLAVE STATION DEVICE, AND OPTICAL COMMUNICATION METHOD

(71) Applicant: Sumitomo Electric Industries, Ltd., Osaka-shi, Osaka (JP)

(72) Inventors: Yusuke MIYAZEKI, Osaka-shi, Osaka (JP); Tomoyuki FUNADA, Osaka-shi, Osaka (JP); Keisuke JINEN, Osaka-shi, Osaka (JP); Isao KATSURA, Osaka-shi, Osaka (JP); Daisuke KAWASE, Osaka-shi, Osaka (JP); Naruto TANAKA, Osaka-shi, Osaka (JP)

(73) Assignee: Sumitomo Electric Industries, Ltd., Osaka-shi, Osaka (JP)

(21) Appl. No.: 18/842,515

(22) PCT Filed: Feb. 21, 2023
(86) PCT No.: PCT/JP2023/006100

§ 371 Date: Aug. 29, 2024

(30) Foreign Application Priority Data
Mar. 1, 2022 (JP) 2022-030713

(51) Int. Cl. H04B 10/077; H04B 10/2575; H04L 7/02

(52) U.S. Cl. CPC H04B 10/077; H04B 10/2575; H04L 7/02

(57) ABSTRACT

An optical communication system includes a master station device, and a slave station device. The master station device generates a first digital signal including control information, and transmits, to the slave station device, a downlink optical signal including the generated first digital signal and an analog main signal. The slave station device acquires the first digital signal included in the downlink optical signal received from the master station device, and performs a loop-back process of transmitting an uplink optical signal including the acquired first digital signal to the master station device. The master station device acquires the control information from the first digital signal included in the uplink optical signal received from the slave station device.

### TECHNICAL FIELD

The present disclosure relates to an optical communication system, a master station device, a slave station device, and an optical communication method.

This application claims priority on Japanese Patent Application No. 2022-30713 filed on Mar. 1, 2022, the entire content of which is incorporated herein by reference.

### BACKGROUND ART

PATENT LITERATURE 1 (Japanese Laid-Open Patent Publication No. 2008-22144) discloses an optical transmission system as follows. That is, in the optical transmission system, an optical signal, which is digitally modulated by a radio frequency signal used for radio section communication of a mobile communication system, is bidirectionally transmitted between a master station device connected to a base station of the mobile communication system and a slave station device connected to the master station device via an optical transmission line. In this optical transmission system, the master station device includes: a pattern generator that generates a reference signal having a unique pattern; and a delay time measurement unit that measures a delay time in a transmission section between the master station device and the slave station device being a connection destination, based on a time that has elapsed from a transmission time to a reception time of the optical signal including the reference signal. The slave station device includes loop-back means that loops back the optical signal including the reference signal to the master station device being a connection destination.

PATENT LITERATURE 2 (Japanese Laid-Open Patent Publication No. 2020-43448) discloses a mobile communication system as follows. That is, the mobile communication system includes a processing device and a wireless device that communicates with the processing device in a radio-over-fiber manner, and includes a first base station device providing a first cell and a second base station device providing a second cell having an overlapping area with the first cell. The mobile communication system includes: first notification means that communicates with the second base station device, and notifies a user device existing in the first cell of a transmission timing of a test signal having a frequency that the wireless device can receive; and second notification means that notifies the processing device of the transmission timing of the test signal notified to the user device.

### CITATION LIST

### Patent Literature

PATENT LITERATURE 1: Japanese Laid-Open Patent Publication No. 2008-22144

PATENT LITERATURE 2: Japanese Laid-Open Patent Publication No. 2020-43448

### Non-Patent Literature

NON-PATENT LITERATURE 1: IEEE Std 1588-2008, “IEEE Standard for a Precision Clock Synchronization Protocol for Networked Measurement and Control Systems” 2008

### SUMMARY OF THE INVENTION

An optical communication system according to the present disclosure includes a master station device and a slave station device. The master station device generates a first digital signal including control information, and transmits, to the slave station device, a downlink optical signal including the generated first digital signal and an analog main signal. The slave station device acquires the first digital signal included in the downlink optical signal received from the master station device, and performs a loop-back process of transmitting an uplink optical signal including the acquired first digital signal to the master station device. The master station device acquires the control information from the first digital signal included in the uplink optical signal received from the slave station device.

A master station device according to the present disclosure includes: a generation unit configured to generate a first digital signal including control information; a transmission unit configured to transmit, to another device, a downlink optical signal including the first digital signal generated by the generation unit, and an analog main signal; a reception unit configured to receive, from the other device, an uplink optical signal including the first digital signal that the other device has acquired from the downlink optical signal; and an acquisition unit configured to acquire the control information from the first digital signal included in the uplink optical signal received by the reception unit.

A slave station device according to the present disclosure includes: a reception unit configured to receive, from another device, a downlink optical signal that includes a first digital signal including control information, and an analog main signal; an acquisition unit configured to acquire the first digital signal included in the downlink optical signal received by the reception unit; and a transmission unit configured to transmit, to the other device, an uplink optical signal including the first digital signal acquired by the acquisition unit.

An optical communication method according to the present disclosure is an optical communication method in an optical communication system including a master station device and a slave station device, and the method includes: by the master station device, generating a first digital signal including control information, and transmitting a downlink optical signal including the generated first digital signal and an analog main signal to the slave station device; by the slave station device, acquiring the first digital signal included in the downlink optical signal received from the master station device, and performing a loop-back process of transmitting an uplink optical signal including the acquired first digital signal to the master station device; and by the master station device, acquiring the control information from the first digital signal included in the uplink optical signal received from the slave station device.

One mode of the present disclosure can be realized not only as a master station device including such a characteristic processing unit but also as an optical communication method including such characteristic process steps as well as a program for causing a computer to execute such process steps. Moreover, one mode of the present disclosure can be realized as a semiconductor integrated circuit that realizes a part or the entirety of the master station device.

One mode of the present disclosure can be realized not only as a slave station device including such a characteristic processing unit but also as an optical communication method including such characteristic process steps as well as a program for causing a computer to execute such process steps. Moreover, one mode of the present disclosure can be realized as a semiconductor integrated circuit that realizes a part or the entirety of the slave station device.

### BRIEF DESCRIPTION OF DRAWINGS

FIG. 1 shows a configuration of an optical communication system according to a first embodiment of the present disclosure.

FIG. 2 shows a configuration of a master station device according to the first embodiment of the present disclosure.

FIG. 3 schematically shows an example of a frequency spectrum of an electric signal generated by a multiplexer in the master station device according to the first embodiment of the present disclosure.

FIG. 4 shows a configuration of a slave station device according to the first embodiment of the present disclosure.

FIG. 5 shows an example of a communication sequence in the optical communication system according to the first embodiment of the present disclosure.

FIG. 6 shows a configuration of a master station device according to Modification 1 of the first embodiment of the present disclosure.

FIG. 7 shows a configuration of a slave station device according to Modification 1 of the first embodiment of the present disclosure.

FIG. 8 shows an example of a communication sequence in an optical communication system according to a modification of the first embodiment of the present disclosure.

FIG. 9 shows a configuration of a master station device according to Modification 2 of the first embodiment of the present disclosure.

FIG. 10 shows a configuration of a slave station device according to Modification 2 of the first embodiment of the present disclosure.

FIG. 11 shows a configuration of a master station device according to Modification 3 of the first embodiment of the present disclosure.

FIG. 12 shows a configuration of a slave station device according to Modification 3 of the first embodiment of the present disclosure.

FIG. 13 schematically shows an example of a frequency spectrum of an electric signal that is generated by a multiplexer in the slave station device according to Modification 3 of the first embodiment of the present disclosure.

FIG. 14 shows a configuration of a slave station device according to Modification 4 of the first embodiment of the present disclosure.

FIG. 15 shows a configuration of an optical communication system according to a second embodiment of the present disclosure.

FIG. 16 shows a configuration of a master station device according to the second embodiment of the present disclosure.

FIG. 17 schematically shows an example of a frequency spectrum of an optical signal outputted from an optical coupler in the master station device according to the second embodiment of the present disclosure.

FIG. 18 shows a configuration of a slave station device according to the second embodiment of the present disclosure.

FIG. 19 shows a configuration of a master station device according to Modification 1 of the second embodiment of the present disclosure.

FIG. 20 shows a configuration of a slave station device according to Modification 1 of the second embodiment of the present disclosure.

FIG. 21 shows a configuration of a master station device according to Modification 2 of the second embodiment of the present disclosure.

FIG. 22 shows a configuration of a slave station device according to Modification 2 of the second embodiment of the present disclosure.

FIG. 23 shows a configuration of a slave station device according to Modification 3 of the second embodiment of the present disclosure.

### DETAILED DESCRIPTION

Conventionally, technologies for improving communication performance in optical communication systems have been developed. In an optical communication system, a technology for realizing a loop-back function, etc., by transmitting various kinds of control information between a master station device and a slave station device has been developed.

### Problems to be Solved by the Present Disclosure

Beyond the technologies described in PATENT LITERATURES 1 and 2 and NON-PATENT LITERATURE 1, there is a demand for a technology that can realize a loop-back function between a master station device and a slave station device with a simple configuration, without interrupting communication between the master station device and the slave station device.

The present disclosure is made to solve the above problems, and it is an object of the present invention to provide an optical communication system, a master station device, a slave station device, and an optical communication method that can realize a loop-back function between a master station device and a slave station device with a simple configuration, without interrupting communication between the master station device and the slave station device.

### Effects of the Present Disclosure

According to the present disclosure, it is possible to realize a loop-back function between a master station device and a slave station device with a simple configuration, without interrupting communication between the master station device and the slave station device.

### DESCRIPTION OF EMBODIMENT OF THE PRESENT DISCLOSURE

First, contents of the embodiments of the present disclosure are listed and described.

(1) An optical communication system according to an embodiment of the present disclosure includes a master station device, and a slave station device. The master station device generates a first digital signal including control information, and transmits, to the slave station device, a downlink optical signal including the generated first digital signal and an analog main signal. The slave station device acquires the first digital signal included in the downlink optical signal received from the master station device, and performs a loop-back process of transmitting an uplink optical signal including the acquired first digital signal to the master station device. The master station device acquires the control information from the first digital signal included in the uplink optical signal received from the slave station device.

As described above, the slave station device acquires the first digital signal included in the received downlink optical signal, and performs the loop-back process of transmitting the uplink optical signal including the acquired first digital signal to the master station device. In this configuration, the first digital signal can be transmitted between the master station device and the slave station device while transmitting the main signal between the master station device and the slave station device. Therefore, the loop-back function can be realized between the master station device and the slave station device with a simple configuration, without interrupting communication between the master station device and the slave station device.

(2) In the above (1), the master station device may generate the first digital signal including time information as the control information, acquire the time information from the first digital signal included in the received uplink optical signal, and perform a synchronization process with the slave station device, based on the acquired time information.

In the above configuration, the transmission delay time of the first digital signal between the master station device and the slave station device can be calculated while transmitting the main signal between the master station device and the slave station device, and the master station device and the slave station device can be synchronized with each other with a simple configuration, based on the calculated transmission delay time.

(3) In the above (1) or (2), the master station device may generate a second digital signal including information indicating a timing at which the slave station device performs the loop-back process, and further transmit a downlink optical signal including the generated second digital signal to the slave station device.

In this configuration, for example, the slave station device can perform the loop-back process during a period in which transmission of the main signal from the slave station device to the master station device is not performed. Therefore, it is possible to inhibit reduction in transmission quality of the main signal due to influences of harmonics of the first digital signal when the main signal and the first digital signal are frequency-multiplexed.

(4) In any of the above (1) to (3), in the loop-back process, the slave station device may be able to loop back the first digital signal at a plurality of different positions in a transmission path inside the slave station device to transmit the first digital signal to the master station device, and the master station device may generate a third digital signal including positional information indicating positions at which the first digital signal is to be looped back, and further transmit a downlink optical signal including the generated third digital signal to the slave station device.

In this configuration, it is possible to measure an RTT (Round Trip Time) of control information between the master station device and the plurality of different positions in the transmission path inside the slave station device.

(5) In any of the above (1) to (4), the slave station device may acquire the control information from the first digital signal, generate a fourth digital signal that includes processing time information indicating a processing time required for processing the acquired control information, and further transmit an uplink optical signal including the generated fourth digital signal to the master station device.

In this configuration, for example, the master station device and the slave station device can be synchronized with each other, based on the RTT of the control information, while also considering the processing time required for processing the control information in the slave station device.

(6) In any of the above (1) to (5), in the loop-back process, the slave station device may branch the acquired first digital signal, and transmit an uplink optical signal including the branched first digital signal to the master station device.

In this consideration, while processing the control information included in one branched first digital signal in the slave station device, the other branched first digital signal can be transmitted to the master station device. Therefore, the loop-back function can be realized between the master station device and the slave station device, without interrupting communication using the first digital signal between the master station device and the slave station device.

(7) A master station device according to the embodiment of the present disclosure includes: a generation unit configured to generate a first digital signal including control information; a transmission unit configured to transmit, to another device, a downlink optical signal including the first digital signal generated by the generation unit, and an analog main signal; a reception unit configured to receive, from the other device, an uplink optical signal including the first digital signal that the other device has acquired from the downlink optical signal; and an acquisition unit configured to acquire the control information from the first digital signal included in the uplink optical signal received by the reception unit.

As described above, the master station device transmits the downlink optical signal including the first digital signal and the main signal to the other device, receives, from the other device, the uplink optical signal including the first digital signal that the other device has acquired from the downlink optical signal, and acquires the control information from the first digital signal. In this configuration, the first digital signal can be transmitted between the master station device and the slave station device while transmitting the main signal between the master station device and the slave station device. Therefore, the loop-back function can be realized between the master station device and the slave station device with a simple configuration, without interrupting communication between the master station device and the slave station device.

(8) A slave station device according to the embodiment of the present disclosure includes: a reception unit configured to receive, from another device, a downlink optical signal that includes a first digital signal including control information, and an analog main signal; an acquisition unit configured to acquire the first digital signal included in the downlink optical signal received by the reception unit; and a transmission unit configured to transmit, to the other device, an uplink optical signal including the first digital signal acquired by the acquisition unit.

As described above, the slave station device acquires the first digital signal included in the received downlink optical signal, and performs the loop-back process of transmitting the uplink optical signal including the acquired first digital signal to the master station device. In this configuration, the first digital signal can be transmitted between the master station device and the slave station device while transmitting the main signal between the master station device and the slave station device. Therefore, the loop-back function can be realized between the master station device and the slave station device with a simple configuration, without interrupting communication between the master station device and the slave station device.

(9) An optical communication method according to the embodiment of the present disclosure is an optical communication method in an optical communication system including a master station device and a slave station device, and the method includes: by the master station device, generating a first digital signal including control information, and transmitting a downlink optical signal including the generated first digital signal and an analog main signal to the slave station device; by the slave station device, acquiring the first digital signal included in the downlink optical signal received from the master station device, and performing a loop-back process of transmitting an uplink optical signal including the acquired first digital signal to the master station device; and by the master station device, acquiring the control information from the first digital signal included in the uplink optical signal received from the slave station device.

As described above, the slave station device acquires the first digital signal included in the received downlink optical signal, and performs the loop-back process of transmitting the uplink optical signal including the acquired first digital signal to the master station device. In this method, the first digital signal can be transmitted between the master station device and the slave station device while transmitting the main signal between the master station device and the slave station device. Therefore, the loop-back function can be realized between the master station device and the slave station device with a simple configuration, without interrupting communication between the master station device and the slave station device.

Hereinafter, embodiments of the present disclosure will be described with reference to the drawings. In the drawings, the same or corresponding parts are denoted by the same reference signs, and description thereof is not repeated. At least some parts of the embodiments described below may be combined together as desired.

### First Embodiment

### Configuration and Basic Operation

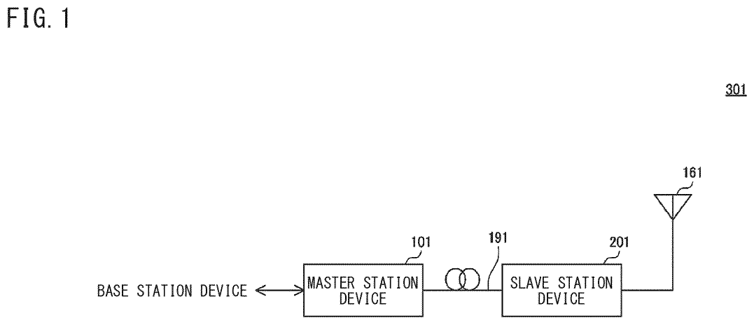

FIG. 1 shows a configuration of an optical communication system according to the first embodiment of the present disclosure. With reference to FIG. 1, an optical communication system 301 includes a master station device 101 and a slave station device 201. The master station device 101 and the slave station device 201 are connected to each other via an optical fiber 191. The optical communication system 301 may be configured to include a plurality of slave station devices 201. In this case, for example, the plurality of slave station devices 201 are connected to the master station device 101 via an optical fiber 191 and an optical coupler. For example, the optical communication system 301 is an analog RoF (Radio over Fiber) system.

The master station device 101 and the slave station device 201 transmit and receive an optical signal including communication data via the optical fiber 191. Hereinafter, an optical signal transmitted from the master station device 101 to the slave station device 201 is also referred to as a downlink optical signal, and an optical signal transmitted from the slave station device 201 to the master station device 101 is also referred to as an uplink optical signal.

When the optical communication system 301 is applied to mobile radio communication, for example, the TDD (Time Division Duplex) system is adopted for the mobile radio communication. Thus, in the optical communication system 301, an uplink transmission period for transmitting communication data from the slave station device 201 to the master station device 101 and a downlink transmission period for transmitting communication data from the master station device 101 to the slave station device 201 are switched and alternately repeated.

More specifically, the master station device 101 receives an OFDM (Orthogonal Frequency Division Multiplexing) modulated analog signal including communication data from a base station device (not shown). The master station device 101 frequency-converts the received analog signal to generate an IF (Intermediate Frequency) signal FSa. The IF signal FSa is an example of a main signal. During the downlink transmission period, the master station device 101 transmits a downlink optical signal including the generated IF signal FSa to the slave station device 201 via the optical fiber 191.

The slave station device 201 receives the downlink optical signal from the master station device 101 via the optical fiber 191. The slave station device 201 acquires the IF signal FSa from the received downlink optical signal, and transmits an RF (Radio Frequency) based on the acquired IF signal FSa via an antenna 161. The slave station device 201 may be configured to transmit the signal based on the acquired IF signal FSa to another device via wires.

The slave station device 201 receives a millimeter-wave-band RF signal that includes communication data and is OFDM-modulated, from a mobile communication terminal (not shown) via the antenna 161, and frequency-converts the received RF signal to generate an IF signal FSb. During the uplink transmission period, the slave station device 201 transmits an uplink optical signal including the generated IF signal FSb to the master station device 101 via the optical fiber 191. The slave station device 201 may be configured to receive a signal including communication data via wires, instead of receiving the RF signal from the mobile communication terminal (not shown) via the antenna 161.

The master station device 101 receives the uplink optical signal from the slave station device 201 via the optical fiber 191. The master station device 101 acquires the IF signal FSb from the received uplink optical signal, and transmits a signal based on the acquired IF signal FSb to the base station device.

In addition, the master station device 101 generates a digital signal DSa including control information. The digital signal DSa is an example of a first digital signal. For example, the master station device 101 generates a digital signal DSa including TS (Time Stamp) information as the control information. Details of the TS information will be described below. The master station device 101 transmits a downlink optical signal OPd1 including the generated digital signal DSa and IF signal FSa to the slave station device 201 via the optical fiber 191. The TS information is an example of time information.

The slave station device 201 receives the downlink optical signal OPd1 from the master station device 101 via the optical fiber 191. The slave station device 201 acquires the digital signal DSa included in the received downlink optical signal OPd1, and performs a loop-back process of transmitting an uplink optical signal OPu1 including the acquired digital signal DSa to the master station device 101 via the optical fiber 191. For example, in the loop-back process, the slave station device 201 branches the acquired digital signal DSa, and transmits an uplink optical signal OPu1 including one branched digital signal DSa to the master station device 101 via the optical fiber 191.

The master station device 101 acquires the TS information as the control information from the digital signal DSa included in the optical signal OPu1 received from the slave station device 201 via the optical fiber 191. For example, the master station device 101 performs a synchronization process with the slave station device 201, based on the acquired TS information.

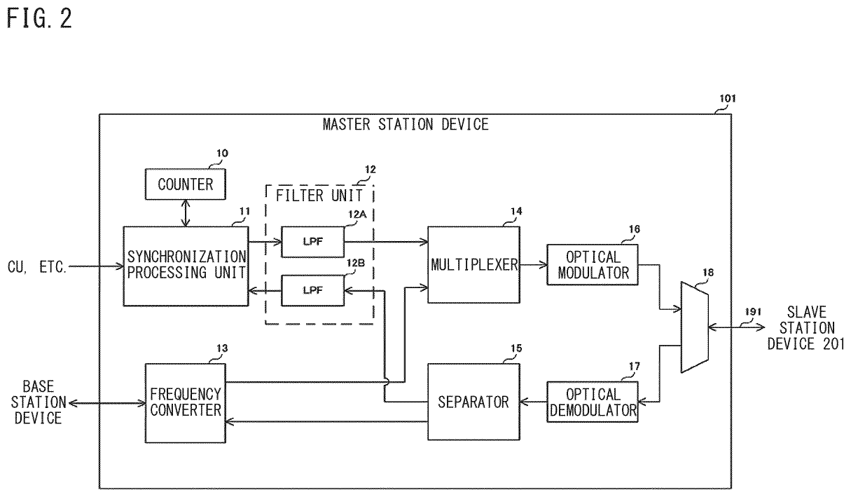

FIG. 2 shows a configuration of a master station device according to the first embodiment of the present disclosure. With reference to FIG. 2, the master station device 101 includes a counter 10, a synchronization processing unit 11, a filter unit 12, a frequency converter 13, a multiplexer 14, a separator 15, an optical modulator 16, an optical demodulator 17, and an optical coupler 18. The filter unit 12 includes LPFs (Low Pass Filters) 12A, 12B. The synchronization processing unit 11 is an example of a generation unit, and an example of an acquisition unit. The optical modulator 16 is an example of a transmission unit. The optical demodulator 17 is an example of a reception unit. A part or the entirety of the synchronization processing unit 11 and the frequency converter 13 is realized by, for example, processing circuitry including one or a plurality of processors.

For example, a local clock generator (not shown) in the master station device 101 receives a reference clock from an oscillator disposed outside or inside the master station device 101, and divides or multiplies the received reference clock to generate a local clock CL1 having a frequency f1. Each of the units in the master station device 101 is operated based on the local clock CL1.

The counter 10 counts the local clock CL1, and holds the count value.

The frequency converter 13 receives an OFDM-modulated analog signal including communication data from a base station device (not shown). The frequency converter 13 may be configured to receive an RF signal or a baseband signal as the analog signal. The frequency converter 13 up-converts or down-converts the received analog signal to generate an IF signal FSa having a center frequency fa, and outputs the generated IF signal FSa to the multiplexer 14.

The synchronization processing unit 11 periodically or non-periodically receives a synchronization signal from an external device (not shown) such as a CU (Central Unit) or a GPS (Global Positioning System) device. The synchronization processing unit 11 performs an external synchronization process of synchronizing the count value of the counter 10 with the external device, based on the received synchronization signal.

The synchronization processing unit 11 generates a digital signal DSa including TS information. More specifically, after completion of the external synchronization process, the synchronization processing unit 11 acquires the current count value of the counter 10, and generates an Ethernet (registered trademark) frame which is addressed to the slave station device 201 and in which the TS information indicating the acquired count value is stored in the payload.

For example, the synchronization processing unit 11 generates an Ethernet frame further including, as the control information, beamforming information for controlling an RF signal transmission direction, and register control information for controlling registers of an FPGA (Field-Programmable Gate Array) in the slave station device 201. Also, the synchronization processing unit 11 generates, for example, an Ethernet frame including a MAC address of the slave station device 201 as a destination MAC address. The synchronization processing unit 11 outputs a binary digital signal DSa including the generated Ethernet frame to the LPF 12A in the filter unit 12.

The LPF 12A receives the digital signal DSa from the synchronization processing unit 11, and attenuates frequency components equal to or higher than a predetermined frequency in the received digital signal DSa. For example, the LPF 12A is a Bessel filter which has a filter order of 4 or more and attenuates frequency components equal to or higher than a cutoff frequency fca. The cutoff frequency fca is lower than the center frequency fa of the IF signal FSa generated by the frequency converter 13. The LPF 12A outputs, to the multiplexer 14, the digital signal DSa in which the frequency components equal to or higher than the cutoff frequency fc have been attenuated.

For example, the multiplexer 14 frequency-multiplexes the signal having passed through the LPF 12A, with the IF signal FSa. More specifically, the multiplexer 14 frequency-multiplexes the digital signal DSa received from the LPF 12A, with the IF signal FSa received from the frequency converter 13. The multiplexer 14 generates an electric signal in which the digital signal DSa and the IF signal FSa are frequency-multiplexed, and outputs the electric signal to the optical modulator 16.

The master station device 101 may be configured to receive an IF signal FSa from the base station device, and transmit a downlink optical signal including the received IF signal FSa to the slave station device 201 via the optical fiber 191. More specifically, the master station device 101 may not necessarily include the frequency converter 13. In this case, the multiplexer 14 receives the IF signal FSa from the base station device (not shown), and frequency-multiplexes the digital signal DSa received from the LPF 12A, with the IF signal FSa received from the base station device.

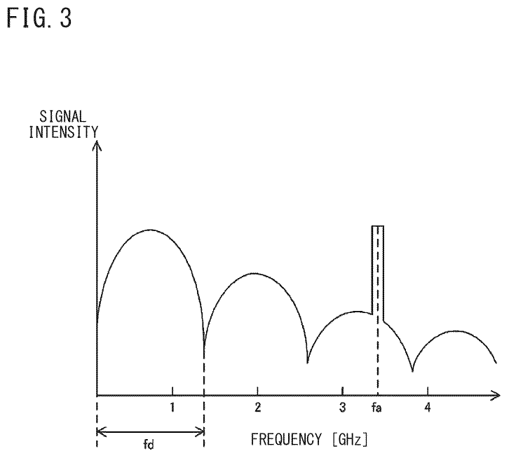

FIG. 3 schematically shows an example of a frequency spectrum of an electric signal generated by a multiplexer in the master station device according to the first embodiment of the present disclosure. In FIG. 3, the horizontal axis represents frequency [GHz], and the vertical axis represents signal intensity.

With reference FIG. 3, the frequency converter 13 generates an IF signal FSa having a center frequency fa in a frequency domain other than a frequency domain in which the intensity of harmonics of the digital signal DSa generated by the synchronization processing unit 11 drops, and outputs the IF signal FSa to the multiplexer 14. More specifically, the frequency converter 13 generates an IF signal FSa having a center frequency fa that satisfies the following formula (1), and outputs the IF signal FSa to the multiplexer 14.

n×fd+k×fd<fa<(n+1)×fd−k×fd (1)

In formula (1), n is an integer not less than 1, k is a value larger than zero and smaller than 0.1, and fd is a bandwidth of control information. Since the frequency converter 13 is configured to generate the IF signal FSa having the center frequency fa that satisfies the above formula (1), it is possible to inhibit reduction in transmission quality of the IF signal FSa due to influences of DC component noise that occurs when the duty ratio of the digital signal DSa generated by the synchronization processing unit 11 is not 50%.

The optical modulator 16 transmits a downlink optical signal OPd1 including the digital signal DSa generated by the synchronization processing unit 11 and the IF signal FSa to the slave station device 201 via the optical fiber 191. More specifically, the optical modulator 16 receives the electric signal from the multiplexer 14, and generates a downlink optical signal OPd1 having a wavelength λ1 by optically modulating the received electric signal. During the downlink transmission period, the optical modulator 16 outputs the downlink optical signal OPd1 to the optical fiber 191 via the optical coupler 18.

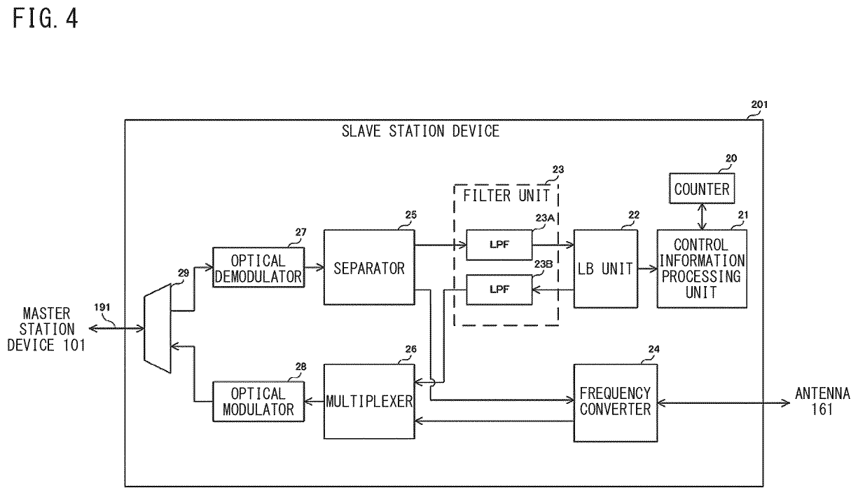

FIG. 4 shows a configuration of a slave station device according to the first embodiment of the present disclosure. With reference to FIG. 4, the slave station device 201 includes a counter 20, a control information processing unit 21, an LB (Loop Back) unit 22, a filter unit 23, a frequency converter 24, a separator 25, a multiplexer 26, an optical demodulator 27, an optical modulator 28, and an optical coupler 29. The optical demodulator 27 is an example of a reception unit. The separator 25 is an example of an acquisition unit. The optical modulator 28 is an example of a transmission unit. A part or the entirety of the control information processing unit 21 and the frequency converter 24 is realized by, for example, processing circuitry including one or a plurality of processors.

A local clock generator (not shown) in the slave station device 201 receives, for example, a reference clock from an oscillator disposed outside or inside the slave station device 201, and divides or multiplies the received reference clock to generate a local clock CL2 having a frequency f2. Each of the units in the slave station device 201 is operated based on the local clock CL2. The frequency of the local clock CL2 is equal to the local clock CL1 in the master station device 101.

The counter 20 counts the local clock CL2, and holds the count value.

The optical demodulator 27 receives the downlink optical signal OPd1 from the master station device 101 via the optical fiber 191 and the optical coupler 29, and generates an electric signal based on the received downlink optical signal OPd1. More specifically, the optical demodulator 27 generates an electric signal having a level according to the intensity of the received downlink optical signal OPd1, and outputs the electric signal to the separator 25.

The separator 25 acquires the digital signal DSa included in the downlink optical signal OPd1 received by the optical demodulator 27. More specifically, the separator 25 receives the electric signal from the optical demodulator 27, separates the IF signal FSa and the digital signal DSa included in the received electric signal from each other, outputs the IF signal FSa to the frequency converter 24, and outputs the digital signal DSa to an LPF 23A in the filter unit 23.

For example, the separator 25 is a diplexer composed of an HPF (High Pass Filter) and an LPF. The separator 25 outputs frequency components equal to or higher than a frequency Fx in the electric signal received from the optical demodulator 27 as the IF signal FSa to the frequency converter 24, and outputs frequency components lower than the frequency Fx as the digital signal DSa to the LPF 23A. Here, the frequency Fx is lower than the center frequency fa of the IF signal FSa.

For example, the frequency converter 24 up-converts the IF signal FSa received from the separator 25 to generate an RF signal, and outputs the generated RF signal to the antenna 161. Alternatively, the frequency converter 24 down-converts the IF signal FSa received from the separator 25 to generate a baseband signal, and transmits the generated baseband signal to a device outside the slave station device 201.

The LPF 23A receives the digital signal DSa from the separator 25, and attenuates frequency components equal to or higher than a predetermined frequency in the received digital signal DSa. For example, the LPF 23A is a Bessel filter which has a filter order of 4 or more and attenuates frequency components equal to or higher than a cutoff frequency fca. The LPF 23 A outputs, to the LB unit 22, the digital signal DSa in which the frequency components equal to or higher than the cutoff frequency fca have been attenuated.

The LB unit 22 is a multiplexer having a function of looping back the digital signal DSa received from the LPF 23A. More specifically, the LB unit 22 branches the digital signal DSa received from the LPF 23A into two lines. The LB unit 22 outputs one branched digital signal DSa to the control information processing unit 21. The LB unit 22 outputs the other digital signal DSa to an LPF 23B in the filter unit 23. That is, the LB unit 22 loops back the digital signal DSa and puts the same on the uplink transmission path.

The control information processing unit 21 receives the digital signal DSa from the LB unit 22, and acquires the Ethernet frame from the received digital signal DSa. If the destination MAC address included in the acquired Ethernet frame does not match the MAC address of the slave station device 201, the control information processing unit 21 discards the Ethernet frame. Meanwhile, if the destination MAC address included in the acquired Ethernet frame matches the MAC address of the slave station device 201, the control information processing unit 21 acquires the control information from the payload of the Ethernet frame. The control information processing unit 21 processes the acquired control information. More specifically, for example, the control information processing unit 21 performs a process of controlling the direction of a beam outputted from the antenna 161, according to beamforming information as an example of control information.

The frequency converter 24 receives an OFDM-modulated analog signal including communication data from the mobile communication terminal (not shown) via the antenna 161. The frequency converter 24 may be configured to receive, as an analog signal, an RF signal from the mobile communication terminal (not shown) via the antenna 161, or a baseband signal via wires. The frequency converter 24 up-converts or down-converts the received analog signal to generate an IF signal FSb having a center frequency fb, and outputs the generated IF signal FSb to the multiplexer 26.

The LPF 23B receives the digital signal DSa from the LB unit 22, and attenuates frequency components equal to or higher than a predetermined frequency in the received digital signal DSa. For example, the LPF 23B is a Bessel filter which has a filter order of 4 or more and attenuates frequency components equal to or higher than a cutoff frequency fcb. The cutoff frequency fcb is lower than the center frequency fb of the IF signal FSb generated by the frequency converter 24. The LPF 23B outputs, to the multiplexer 26, the digital signal DSa in which the frequency components equal to or higher than the cutoff frequency fcb have been attenuated.

For example, the multiplexer 26 frequency-multiplexes the signal having passed through the LPF 23B, with the IF signal FSb. More specifically, the multiplexer 26 frequency-multiplexes the digital signal DSa received from the LPF 23B, with the IF signal FSb received from the frequency converter 24. The multiplexer 26 generates an electric signal in which the digital signal DSa and the IF signal FSb are frequency-multiplexed, and outputs the electric signal to the optical modulator 28.

The optical modulator 28 transmits an uplink optical signal OPu1 including the digital signal DSa acquired by the separator 25 to the master station device 101 via the optical fiber 191. More specifically, the optical modulator 28 receives the electric signal from the multiplexer 26, and generates an uplink optical signal OPu1 having a wavelength λ2 by optically modulating the received electric signal. During the uplink transmission period, the optical modulator 28 outputs the uplink optical signal OPu1 to the optical fiber 191 via the optical coupler 29.

Referring back to FIG. 2, the optical demodulator 17 in the master station device 101 receives the uplink optical signal OPu1 including the digital signal DSa that the slave station device 201 has acquired from the downlink optical signal OPd1, from the slave station device 201 via the optical fiber 191 and the optical coupler 18, and generates an electric signal based on the received uplink optical signal OPu1. More specifically, the optical demodulator 17 generates an electric signal having a level according to the intensity of the received uplink optical signal OPu1, and outputs the electric signal to the separator 15.

The separator 15 receives the electric signal from the optical demodulator 17, separates the IF signal FSb and the digital signal DSa included in the received electric signal from each other, outputs the IF signal FSb to the frequency converter 13, and outputs the digital signal DSa to an LPF 12B in the filter unit 12.

For example, the separator 15 is a diplexer composed of an HPF and an LPF. The separator 15 outputs frequency components equal to or higher than a frequency Fy in the electric signal received from the optical demodulator 17, as the IF signal FSb to the frequency converter 13, and outputs frequency components lower than the frequency Fy as the digital signal DSa to the LPF 12B. Here, the frequency Fy is lower than the center frequency fb of the IF signal FSb. As described above, the master station device 101 may not necessarily include the frequency converter 13. In this case, the separator 15 transmits the IF signal FSb to the base station device (not shown).

For example, the frequency converter 13 up-converts the IF signal FSb received from the separator 15 to generate an RF signal, and outputs the generated RF signal to the base station device. Alternatively, the frequency converter 13 down-converts the IF signal FSb received from the separator 15 to generate a baseband signal, and transmits the generated baseband signal to the base station device.

The LPF 12B receives the digital signal DSa from the separator 15, and attenuates frequency components equal to or higher than a predetermined frequency in the received digital signal DSa. For example, the LPF 12B is a Bessel filter which has a filter order of 4 or more and attenuates frequency components equal to or higher than a cutoff frequency fcb. The LPF 12B outputs, to the synchronization processing unit 11, the digital signal DSa in which the frequency components equal to or higher than the cutoff frequency fcb have been attenuated.

The synchronization processing unit 11 acquires the TS information from the digital signal DSa included in the uplink optical signal OPu1 received by the optical demodulator 17. More specifically, the synchronization processing unit 11 receives the digital signal DSa from the LPF 12B, and acquires the Ethernet frame from the received digital signal DSa. The synchronization processing unit 11 acquires the TS information from the payload of the Ethernet frame.

The synchronization processing unit 11 performs a synchronization process with the slave station device 201, based on the acquired TS information. More specifically, the synchronization processing unit 11 acquires the TS information, and acquires the current count value of the counter 10 as a TS information reception time. For example, the synchronization processing unit 11 calculates a difference Dcnt between the count value indicated by the acquired TS information and the current count value of the counter 10, as a round trip time RTT of the TS information. Furthermore, for example, the synchronization processing unit 11 calculates ½ of the difference Dent as a transmission delay time DT between the master station device 101 and the slave station device 201.

After calculation of the transmission delay time DT, the synchronization processing unit 11 acquires the current count value of the counter 10, and generates synchronization information including a synchronization time ST1 which is a value obtained by adding the transmission delay time DT to the acquired count value.

The synchronization processing unit 11 transmits the generated synchronization information to the slave station device 201. More specifically, the synchronization processing unit 11 outputs, to the LPF 12A in the filter unit 12, a digital signal DSb including an Ethernet frame which is addressed to the slave station device 201 and in which the synchronization information is stored in the payload.

The LPF 12A receives the digital signal DSb from the synchronization processing unit 11, and attenuates frequency components equal to or higher than the cutoff frequency fca in the received digital signal DSb. The LPF 12A outputs, to the multiplexer 14, the digital signal DSb in which the frequency components equal to or higher than the cutoff frequency fca have been attenuated.

The multiplexer 14 generates an electric signal in which the digital signal DSb received from the LPF 12A is frequency-multiplexed with the IF signal FSa received from the frequency converter 13, and outputs the electric signal to the optical modulator 16.

The optical modulator 16 receives the electric signal from the multiplexer 14, and generates a downlink optical signal OPd2 having a wavelength λ1 by optically modulating the received electric signal. During the downlink transmission period, the optical modulator 16 outputs the downlink optical signal OPd2 to the optical fiber 191 via the optical coupler 18.

If the digital signal DSa from the LPF 12B does not arrive within a predetermined time after the digital signal DSa was outputted to the LPF 12A, the synchronization processing unit 11 may determine that a communication error has occurred in the optical communication system 301.

Referring back to FIG. 4, the optical demodulator 27 in the slave station device 201 receives the downlink optical signal OPd2 from the master station device 101 via the optical fiber 191 and the optical coupler 29, generates an electric signal based on the received downlink optical signal OPd2, and outputs the electric signal to the separator 25.

The separator 25 receives the electric signal from the optical demodulator 27, separates the IF signal FSa and the digital signal DSb included in the received electric signal from each other, outputs the IF signal FSa to the frequency converter 24, and outputs the digital signal DSb to the LPF 23A in the filter unit 23.

The LPF 23A receives the digital signal DSb from the separator 25, and attenuates frequency components equal to or higher than the cutoff frequency fca in the received digital signal DSb. The LPF 23A outputs, to the LB unit 22, the digital signal DSb in which the frequency components equal to or higher than the cutoff frequency fca have been attenuated.

The LB unit 22 branches the digital signal DSb received from the LPF 23A into two lines. The LB unit 22 outputs one branched digital signal DSb to the control information processing unit 21. The LB unit 22 outputs the other branched digital signal DSb to the LPF 23B in the filter unit 23.

The control information processing unit 21 receives the digital signal DSb from the LB unit 22, and acquires the Ethernet frame from the received digital signal DSb. If the destination MAC address included in the acquired Ethernet frame matches the MAC address of the slave station device 201, the control information processing unit 21 acquires the synchronization information from the payload of the Ethernet frame. Upon acquiring the synchronization information, the control information processing unit 21 updates the count value of the counter 20, based on the acquired synchronization information. That is, the control information processing unit 21 sets the count value of the counter 20 to the synchronization time ST1 included in the synchronization information.

### Operation Flow

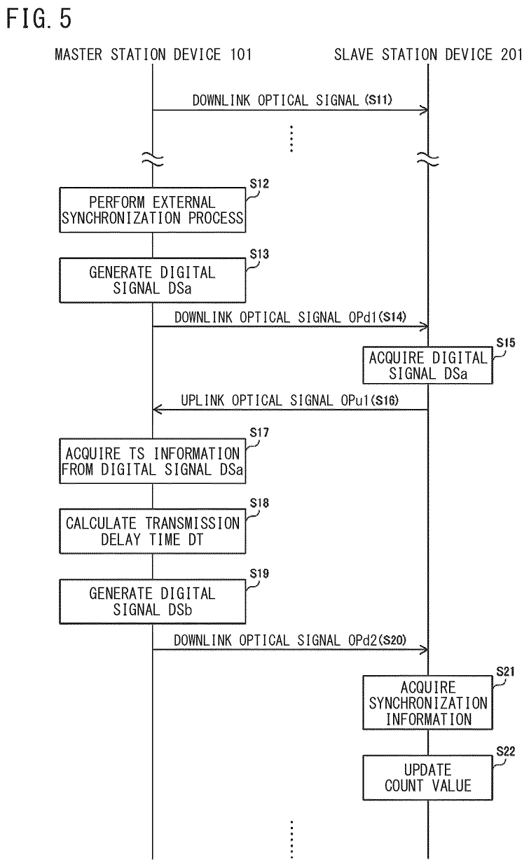

FIG. 5 shows an example of a communication sequence in the optical communication system according to the first embodiment of the present disclosure. With reference to FIG. 5, the master station device 101 transmits a downlink optical signal obtained by optically modulating an IF signal, to the slave station device 201 via the optical fiber 191 (step S11).

Next, the master station device 101 performs an external synchronization process of synchronizing the count value of the counter 10 with an external device, based on a synchronization signal received from the external device such as a CU or a GPS device (step S12).

Next, the master station device 101 generates a digital signal DSa including TS information. More specifically, the master station device 101 generates a digital signal DSa including an Ethernet frame which is addressed to the slave station device 201 and in which the TS information indicating the current count value of the counter 10 is stored in the payload (step S13).

Next, the master station device 101 generates an electric signal in which an IF signal FSa generated by frequency-converting an analog signal including communication data is frequency-multiplexed with the digital signal DSa, and transmits a downlink optical signal OPd1 having a wavelength λ1 and obtained by optically modulating the generated electric signal, to the slave station device 201 via the optical fiber 191 (step S14).

Next, the slave station device 201 receives the downlink optical signal OPd1 from the master station device 101 via the optical fiber 191, and acquires the digital signal DSa included in the received downlink optical signal OPd1 (step S15).

Next, the slave station device 201 generates an electric signal in which an IF signal FSb generated by frequency-converting an analog signal including communication data is frequency-multiplexed with the acquired digital signal DSa, and transmits an uplink optical signal OPu1 having a wavelength λ2 and obtained by optically modulating the generated electric signal, to the master station device 101 via the optical fiber 191 (step S16).

Next, the master station device 101 receives the uplink optical signal OPu1 from the slave station device 201 via the optical fiber 191, and acquires the TS information from the digital signal DSa included in the received uplink optical signal OPu1. More specifically, the master station device 101 acquires the Ethernet frame from the digital signal DSa, and acquires the TS information from the payload of the Ethernet frame (step S17).

Next, the master station device 101 calculates a transmission delay time DT between the master station device 101 and the slave station device 201, based on the acquired TS information. More specifically, the master station device 101 calculates ½ of a difference Dcnt between the count value indicated by the acquired TS information and the current count value of the counter 10, as a transmission delay time DT (step S18).

Next, the master station device 101 generates synchronization information including a synchronization time ST1 which is a value obtained by adding the transmission delay time DT to the current count value of the counter 10, and generates a digital signal DSb including an Ethernet frame which is addressed to the slave station device 201 and in which the synchronization information is stored in the payload (step S19).

Next, the master station device 101 generates an electric signal in which the IF signal FSa and the digital signal DSb are frequency-multiplexed, and transmits a downlink optical signal OPd2 having a wavelength λ1 and obtained by optically modulating the generated electric signal, to the slave station device 201 via the optical fiber 191 (step S20).

Next, the slave station device 201 receives the downlink optical signal OPd2 from the master station device 101 via the optical fiber 191, and acquires the synchronization information from the digital signal DSb included in the received downlink optical signal OPd2. More specifically, the slave station device 201 acquires the Ethernet frame from the digital signal DSb, and acquires the synchronization information from the payload of the Ethernet frame (step S21).

Next, the slave station device 201 updates the count value of the counter 20, based on the acquired synchronization information. That is, the slave station device 201 sets the count value of the counter 20 to the synchronization time ST1 included in the synchronization information (step S22).

### Modification 1

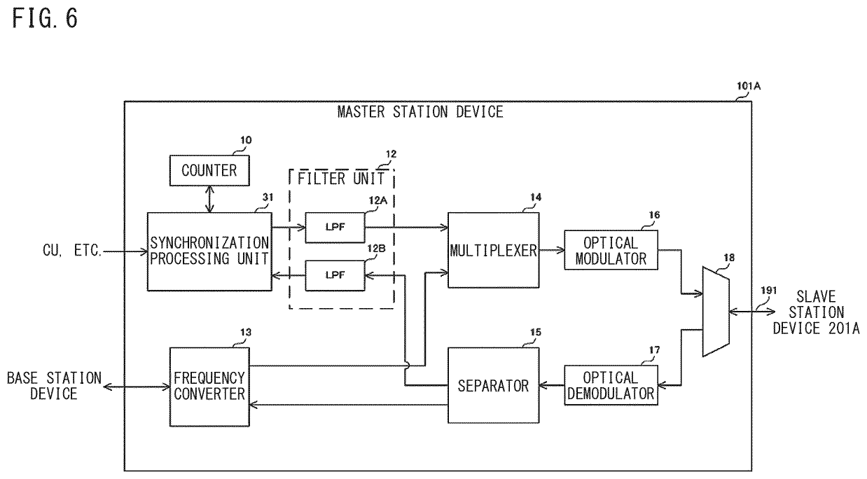

FIG. 6 shows a configuration of a master station device according to Modification 1 of the first embodiment of the present disclosure. With reference to FIG. 6, a master station device 101A includes a synchronization processing unit 31 instead of the synchronization processing unit 11 of the master station device 101.

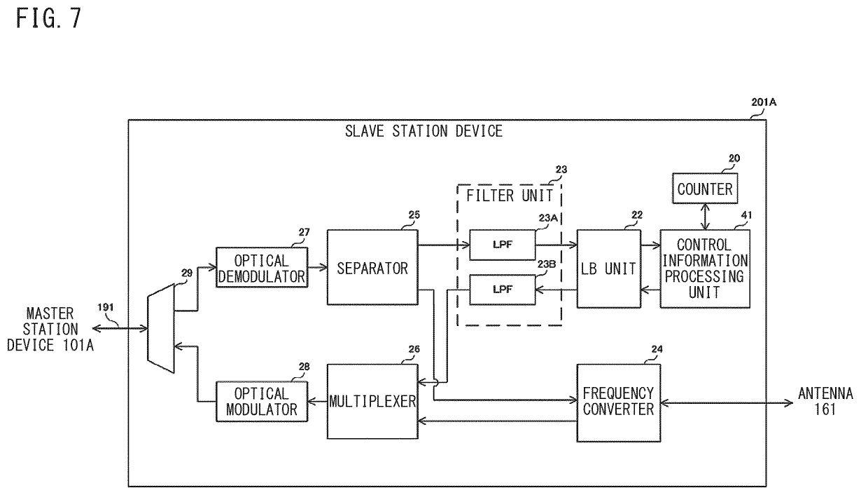

FIG. 7 shows a configuration of a slave station device according to Modification 1 of the first embodiment of the present disclosure. With reference to FIG. 7, the slave station device 201A includes a control information processing unit 41 instead of the control information processing unit 21 of the slave station device 201.

The optical communication system 301 may be configured to include a master station device 101A and a slave station device 201A instead of the master station device 101 and the slave station device 201. The slave station device 201A generates a digital signal DSc that includes processing time information indicating a processing time PT required for processing control information, and further transmits an uplink optical signal OPu2 including the generated digital signal DSc to the master station device 101A via the optical fiber 191. The digital signal DSc is an example of a fourth digital signal. The master station device 101A acquires the processing time information from the uplink optical signal OPu2 received from the slave station device 201A. The master station device 101A sets a synchronization time ST2, based on the processing time PT indicated by the acquired processing time information, and transmits synchronization information indicating the set synchronization time ST2 to the slave station device 201A. The slave station device 201A receives the synchronization information from the master station device 101A, and updates the count value of the counter 20, based on the received synchronization information.

The control information processing unit 41 in the slave station device 201A periodically or non-periodically measures the processing time PT. More specifically, the control information processing unit 41 receives a digital signal DSa from the LB unit 22, and acquires the count value of the counter 20 at the timing when the digital signal DSa is received. In addition, the control information processing unit 41 acquires an Ethernet frame from the received digital signal DSa. If a destination MAC address included in the acquired Ethernet frame matches a MAC address of the slave station device 201A, the control information processing unit 41 acquires control information from the payload of the Ethernet frame, and processes the acquired control information.

Upon completion of the process for the control information, the control information processing unit 41 acquires the count value of the counter at the timing when the process for the control information has been completed. The control information processing unit 41 calculates, as the processing time PT, a difference between the count value of the counter 20 at the timing when the digital signal DSa has been received, and the count value of the counter at the timing when the process for the control information has been completed.

The control information processing unit 41 generates an Ethernet frame which is addressed to the master station device 101A and in which processing time information indicating the calculated processing time PT is stored in the payload, and outputs a digital signal DSc including the generated Ethernet frame to the LB unit 22.

The LB unit 22 outputs the digital signal DSc received from the control information processing unit 41 to the LPF 23B.

The LPF 23B receives the digital signal DSc from the LB unit 22, and attenuates frequency components equal to or higher than the cutoff frequency fcb in the received digital signal DSc. The LPF 23B outputs, to the multiplexer 26, the digital signal DSc in which the frequency components equal to or higher than the cutoff frequency fcb have been attenuated.

For example, the multiplexer 26 generates an electric signal in which the digital signal DSc received from the LPF 23B and the IF signal FSb received from the frequency converter 24 are frequency-multiplexed, and outputs the electric signal to the optical modulator 28.

The optical modulator 28 receives the electric signal from the multiplexer 26, and generates an uplink optical signal OPu2 having a wavelength λ2 by optically modulating the received electric signal. During the uplink transmission period, the optical modulator 28 outputs the uplink optical signal OPu2 to the optical fiber 191 via the optical coupler 29.

The control information processing unit 41 may be configured to output, to the LB unit 22, a digital signal that includes processing time information indicating a start timing and an end timing of measurement of the processing time PT, instead of or in addition to the processing time information indicating the processing time PT.

Referring back to FIG. 6, the optical demodulator 17 in the master station device 101A receives the uplink optical signal OPu2 including the digital signal DSc from the slave station device 201A via the optical fiber 191 and the optical coupler 18, and generates an electric signal based on the received uplink optical signal OPu2. More specifically, the optical demodulator 17 generates an electric signal having a level according to the intensity of the received uplink optical signal OPu2, and outputs the electric signal to the separator 15.

The separator 15 receives the electric signal from the optical demodulator 17, separates the IF signal FSb and the digital signal DSc included in the received electric signal from each other, outputs the IF signal FSb to the frequency converter 13, and outputs the digital signal DSc to the LPF 12B in the filter unit 12.

The LPF 12B receives the digital signal DSc from the separator 15, and attenuates frequency components equal to or higher than the cutoff frequency fcb in the received digital signal DSc. The LPF 12B outputs, to the synchronization processing unit 31, the digital signal DSc in which the frequency components equal to or higher than the cutoff frequency fcb have been attenuated.

The synchronization processing unit 31 receives the digital signal DSc from the LPF 12B, and acquires the Ethernet frame from the received digital signal DSc. The synchronization processing unit 31 acquires the processing time information from the payload of the Ethernet frame.

The synchronization processing unit 31 performs a synchronization process with the slave station device 201, based on the processing time information and the TS information. More specifically, upon acquiring the processing time information, the synchronization processing unit 31 acquires the current count value of the counter 10, and generates synchronization information including a synchronization time ST2 which is a value obtained by adding the transmission delay time DT and the processing time PT indicated by the processing time information to the acquired count value. Then, the synchronization processing unit 31 transmits the generated synchronization information to the slave station device 201.

The slave station device 201A may be configured to, during a predetermined period, transmit an uplink optical signal OPu2 which does not include the IF signal FSb but includes the digital signal DSc, to the master station device 101A via the optical fiber 191.

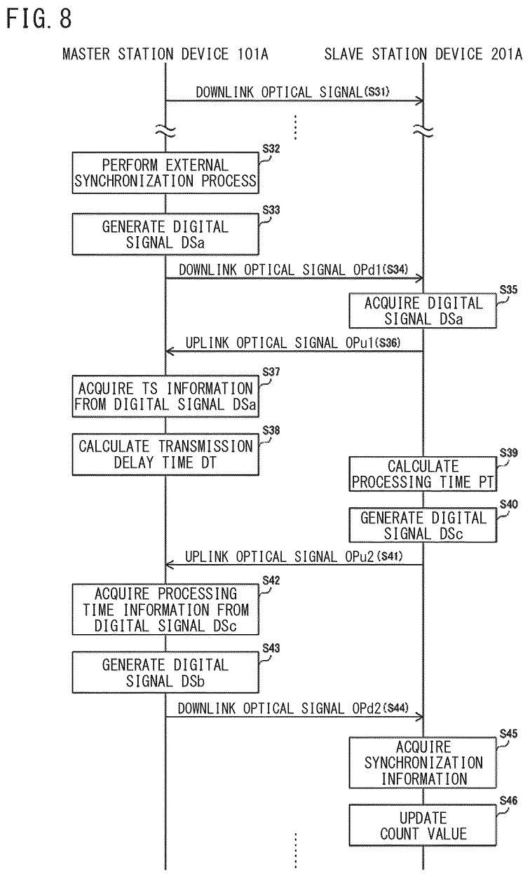

FIG. 8 shows an example of a communication sequence in an optical communication system according to a modification of the first embodiment of the present disclosure.

With reference to FIG. 8, first, the master station device 101A and the slave station device 201A perform, as processes in steps S31 to S38, the same processes as those in steps S11 to S18 shown in FIG. 5.

Next, the slave station device 201A calculates a processing time PT required for processing the control information (step S39).

Next, the slave station device 201A generates a digital signal DSc including an Ethernet frame which is addressed to the master station device 101A and in which the processing time information indicating the processing time PT is stored in the payload (step S40).

Next, the slave station device 201A generates an electric signal in which the IF signal FSb and the digital signal DSc are frequency-multiplexed, and transmits an uplink optical signal OPu2 having a wavelength λ2 and obtained by optically modulating the generated electric signal, to the master station device 101A via the optical fiber 191 (step S41).

Next, the master station device 101A receives the uplink optical signal OPu2 from the slave station device 201A via the optical fiber 191, and acquires the processing time information from the digital signal DSc included in the received uplink optical signal OPu2. More specifically, the master station device 101A acquires the Ethernet frame from the digital signal DSc, and acquires the processing time information from the payload of the Ethernet frame (step S42).

Next, the master station device 101A generates synchronization information including a synchronization time ST2 which is a value obtained by adding the transmission delay time DT and the processing time PT indicated by the processing time information to the current count value of the counter 10, and generates a digital signal DSb including an Ethernet frame which is addressed to the slave station device 201A and in which the synchronization information is stored in the payload (step S43).

Next, the master station device 101A generates an electric signal in which the IF signal FSa and the digital signal DSb are frequency-multiplexed, and transmits a downlink optical signal OPd2 having a wavelength λ1 and obtained by optically modulating the generated electric signal, to the slave station device 201A via the optical fiber 191 (step S44).

Next, the slave station device 201A receives the downlink optical signal OPd2 from the master station device 101A via the optical fiber 191, and acquires the synchronization information from the digital signal DSb included in the received downlink optical signal OPd2. More specifically, the slave station device 201 acquires the Ethernet frame from the digital signal DSb, and acquires the synchronization information from the payload of the Ethernet frame (step S45).

Next, the slave station device 201A updates the count value of the counter 20, based on the acquired synchronization information. That is, the slave station device 201A sets the count value of the counter 20 to the synchronization time ST2 included in the synchronization information (step S46).

### Modification 2

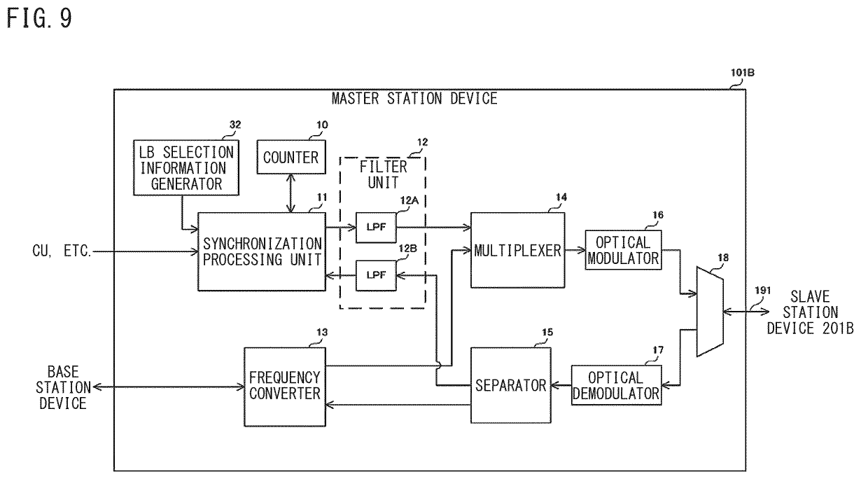

FIG. 9 shows a configuration of a master station device according to Modification 2 of the first embodiment of the present disclosure. With reference to FIG. 9, a master station device 101B further includes an LB selection information generator 32, as compared to the master station device 101.

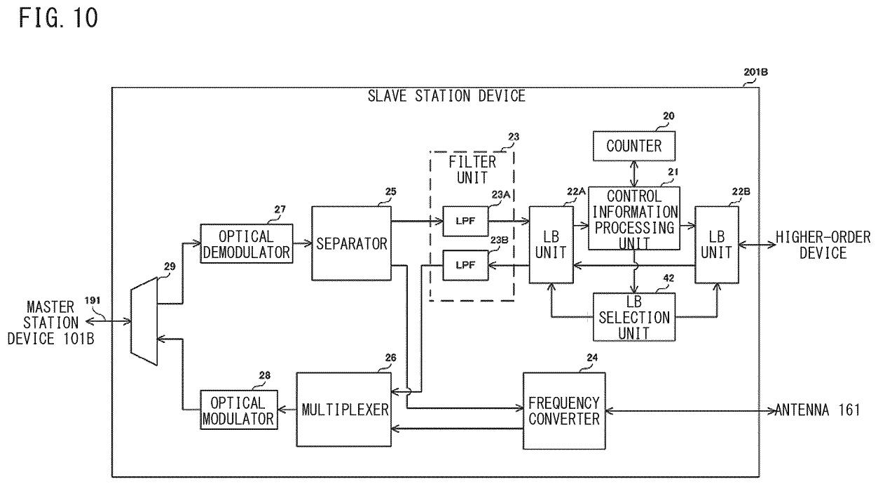

FIG. 10 shows a configuration of a slave station device according to Modification 2 of the first embodiment of the present disclosure. With reference to FIG. 10, a slave station device 201B includes LB units 22A, 22B as the LB unit 22, and further includes an LB selection unit 42, as compared to the slave station device 201.

The LB unit 22 is capable of switching between an LB on state in which the digital signal DSa is looped back, and an LB off state in which the digital signal DSa is not looped back.

The LB unit 22A, in the LB on state, branches the digital signal DSa received from the LPF 23A into two lines, outputs one branched digital signal DSa to the control information processing unit 21, and outputs the other branched digital signal DSa to the LPF 23B in the filter unit 23. The LB unit 22A, in the LB off state, outputs the digital signal DSa received from the LPF 23A to the control information processing unit 21 without branching the same.

The LB unit 22B, in the LB on state, branches the digital signal DSa received from the control information processing unit 21 into two lines, transmits one branched digital signal DSa to, for example, a higher-order device such as an LB unit located outside the slave station device 201B, and outputs the other branched digital signal DSa to the LB unit 22A. The LB unit 22B, in the LB off state, outputs the digital signal DSa received from the control information processing unit 21 to the higher-order device without branching the same.

The LB unit 22A, in the LB off state, outputs the digital signal DSa received from the LB unit 22B to the LPF 23B in the filter unit 23, while the LB unit 22A, in the LB on state, does not output the digital signal DSa received from the LB unit 22B to the LPF 23B. The LB unit 22B, in the LB off state, outputs the digital signal DSa received from the higher-order device to the LB unit 22A, while the LB unit 22B, in the LB on state, does not output the digital signal DSa received from the higher-order device to the LB unit 22A.

The LB unit 22A, in its initial state, is in the LB on state. The LB unit 22B, in its initial state, is in the LB off state.

The optical communication system 301 may be configured to include a master station device 101B and a slave station device 201B instead of the master station device 101 and the slave station device 201. In the loop-back process, the slave station device 201B may transmit the digital signal DSa to the master station device 101A by looping back the digital signal DSa at a plurality of different positions in the transmission path inside the slave station device 201A. The master station device 101A generates a digital signal DSd including LB selection information indicating the positions at which the digital signal DSa is to be looped back, and further transmits a downlink optical signal OPd3 including the generated digital signal DSd to the slave station device 201B. The digital signal DSd is an example of a third digital signal. The LB selection information is an example of positional information.

Referring back to FIG. 9, upon completion of the external synchronization process by the synchronization processing unit 11, the LB selection information generator 32 in the master station device 101B selects an LB unit 22, out of the two LB units 22 in the slave station device 201B, which performs loop-back of the digital signal DSa, and generates LB selection information indicating the selected LB unit 22. The LB selection information generator 32 outputs the generated LB selection information to the synchronization processing unit 11.

The synchronization processing unit 11 receives the LB selection information from the LB selection information generator 32, and generates an Ethernet frame which is addressed to the slave station device 201 and in which the received LB selection information is stored in the payload. The synchronization processing unit 11 outputs the digital signal DSd including the generated Ethernet frame to the LPF 12A, before outputting the digital signal DSa including the TS information to the LPF 12A.

The LPF 12A receives the digital signal DSd from the synchronization processing unit 11, and attenuates frequency components equal to or higher than the cutoff frequency fca in the received digital signal DSd. The LPF 12A outputs, to the multiplexer 14, the digital signal DSd in which the frequency components equal to or higher than the cutoff frequency fca have been attenuated.

The multiplexer 14 generates an electric signal in which the digital signal DSd received from the LPF 12A and the IF signal FSa received from the frequency converter 13 are frequency-multiplexed, and outputs the electric signal to the optical modulator 16.

The optical modulator 16 receives the electric signal from the multiplexer 14, and generates a downlink optical signal OPd3 having a wavelength λ1 by optically modulating the received electric signal. During the downlink transmission period, the optical modulator 16 outputs the downlink optical signal OPd3 to the optical fiber 191 via the optical coupler 18.

Referring back to FIG. 10, the optical demodulator 27 in the slave station device 201B receives the downlink optical signal OPd3 from the master station device 101 via the optical fiber 191 and the optical coupler 29, generates an electric signal based on the received downlink optical signal OPd3, and outputs the electric signal to the separator 25.

The separator 25 receives the electric signal from the optical demodulator 27, separates the IF signal FSa and the digital signal DSd included in the received electric signal from each other, outputs the IF signal FSa to the frequency converter 24, and outputs the digital signal DSd to the LPF 23A in the filter unit 23.

The LPF 23A receives the digital signal DSd from the separator 25, and attenuates frequency components equal to or higher than the cutoff frequency fca in the received digital signal DSd. The LPF 23A outputs, to the LB unit 22A, the digital signal DSd in which the frequency components equal to or higher than the cutoff frequency fca have been attenuated. The LB unit 22A, in the LB on state as the initial state, branches the digital signal DSd received from the LPF 23A, and outputs the branched signal to the control information processing unit 21 and the LPF 23B.

The control information processing unit 21 receives the digital signal DSd from the LB unit 22, and acquires the Ethernet frame from the received digital signal DSd. If the destination MAC address included in the acquired Ethernet frame matches the MAC address of the slave station device 201, the control information processing unit 21 acquires the LB selection information from the payload of the Ethernet frame. The control information processing unit 21 outputs the acquired LB selection information to the LB selection unit 42.

The LB selection unit 42 receives the LB selection information from the control information processing unit 21, and sets the LB unit 22 indicated by the received LB selection information, in the LB on state in which loop-back of the digital signal DSa is performed. As an example, the LB selection unit 42 switches the LB unit 22A to the LB off state, and switches the LB unit 22B to the LB on state, according to the LB selection information.

The LB unit 22A, in the LB off state, receives the digital signal DSa from the LPF 23A, and outputs the received digital signal DSa to the control information processing unit 21 without branching the same.

The control information processing unit 21 receives the digital signal DSa from the LB unit 22A, and outputs the received digital signal DSa to the LB unit 22B.

The LB unit 22B, in the LB on state, receives the digital signal DSa from the control information processing unit 21, and loops back the received digital signal DSa. That is, the LB unit 22B branches the received digital signal DSa into two lines, transmits one branched digital signal DSa to, for example, a higher-order device such as an LB unit located outside the slave station device 201B, and outputs the other branched digital signal DSa to the LB unit 22A.

The LB unit 22A, in the LB off state, outputs the digital signal DSa received from the LB unit 22B to the LPF 23B in the filter unit 23.

The master station device 101B may be configured to, during a predetermined period, transmit an uplink optical signal OPd3 which does not include the IF signal FSa but includes the digital signal DSd, to the slave station device 201B via the optical fiber 191.

### Modification 3

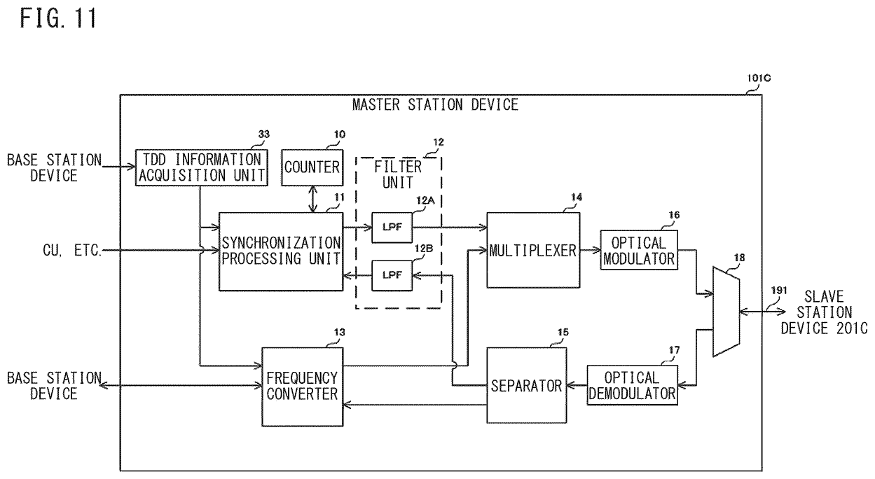

FIG. 11 shows a configuration of a master station device according to Modification 3 of the first embodiment of the present disclosure. With reference to FIG. 11, the master station device 101C further includes a TDD information acquisition unit 33, as compared to the master station device 101.

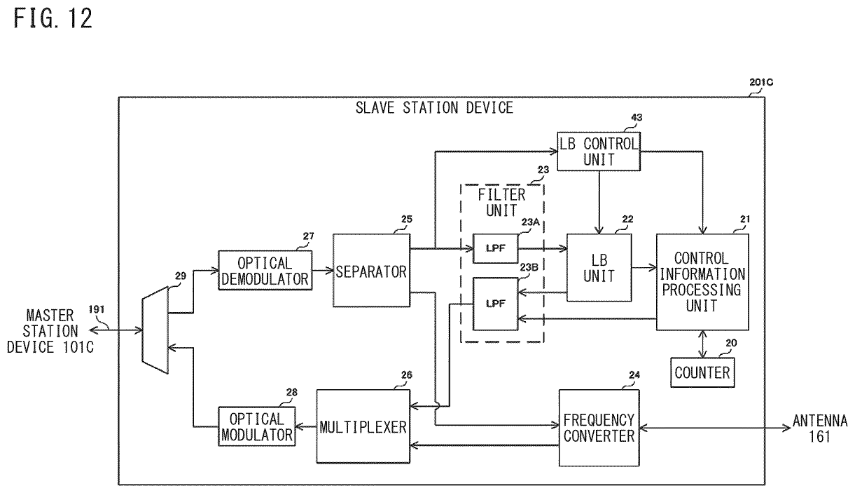

FIG. 12 shows a configuration of a slave station device according to Modification 3 of the first embodiment of the present disclosure. With reference to FIG. 12, the slave station device 201C further includes an LB control unit 43, as compared to the slave station device 201.

The LB unit 22 is capable of switching between the LB on state in which loop-back of the digital signal DSa is performed, and the LB off state in which loop-back of the digital signal DSa is not performed.

The LB unit 22, in the LB on state, branches the digital signal DSa received from the LPF 23A into two lines, outputs one branched digital signal DSa to the control information processing unit 21, and outputs the other branched digital signal DSa to the LPF 23B in the filter unit 23. The LB unit 22, in the LB off state, outputs the digital signal DSa received from the LPF 23A to the control information processing unit 21 without branching the same. In addition, the LB unit 22, in the LB off state, outputs the digital signal received from the control information processing unit 21 to the LPF 23B in the filter unit 23, while the LB unit 22, in the LB on state, does not output the digital signal received from the control information processing unit 21 to the LPF 23B.

The optical communication system 301 may be configured to include a master station device 101C and a slave station device 201C instead of the master station device 101 and the slave station device 201. The master station device 101C generates a digital signal DSe including TDD information indicating a timing at which the slave station device 201C performs the loop-back process, and further transmits a downlink optical signal OPd4 including the generated digital signal DSe to the slave station device. The digital signal DSe is an example of a second digital signal.

Referring back to FIG. 11, for example, the TDD information acquisition unit 33 in the master station device 101C periodically or non-periodically receives, from the base station device, TDD information indicating the uplink transmission period and the downlink transmission period. The TDD information acquisition unit 33 outputs the acquired TDD information to the synchronization processing unit 11 and the frequency converter 13.

The frequency converter 13 receives the TDD information from the TDD information acquisition unit 33, and generates an IF signal FSa and outputs the IF signal FSa to the multiplexer 14 during the downlink transmission period indicated by the received TDD information.

The synchronization processing unit 11 receives the TDD information from the TDD information acquisition unit 33, and generates an Ethernet frame which is addressed to the slave station device 201C and in which the received TDD information is stored in the payload. The synchronization processing unit 11 outputs the digital signal DSe including the generated Ethernet frame to the LPF 12A.

The LPF 12A receives the digital signal DSe from the synchronization processing unit 11, and attenuates frequency components equal to or higher than the cutoff frequency fca in the received digital signal DSe. The LPF 12A outputs, to the multiplexer 14, the digital signal DSe in which the frequency components equal to or higher than the cutoff frequency fca have been attenuated.

The multiplexer 14 generates an electric signal in which the digital signal DSe received from the LPF 12A and the IF signal FSa received from the frequency converter 13 are frequency-multiplexed, and outputs the electric signal to the optical modulator 16.

The optical modulator 16 receives the electric signal from the multiplexer 14, and generates a downlink optical signal OPd4 having a wavelength λ1 by optically modulating the received electric signal. During the downlink transmission period, the optical modulator 16 outputs the downlink optical signal OPd4 to the optical fiber 191 via the optical coupler 18.

Referring back to FIG. 12, the optical demodulator 27 in the slave station device 201C receives the downlink optical signal OPd4 from the master station device 101 via the optical fiber 191 and the optical coupler 29, generates an electric signal based on the received downlink optical signal OPd4, and outputs the electric signal to the separator 25.

The separator 25 receives the electric signal from the optical demodulator 27, separates the IF signal FSa and the digital signal DSe included in the received electric signal from each other, outputs the IF signal FSa to the frequency converter 24, and outputs the digital signal DSe to the LPF 23A in the filter unit 23, and the LB control unit 43.

The LB control unit 43 receives the digital signal DSe from the separator 25, and acquires the Ethernet frame from the received digital signal DSe. If the destination MAC address included in the acquired Ethernet frame matches the MAC address of the slave station device 201, the LB control unit 43 acquires the TDD information from the payload of the Ethernet frame. The LB control unit 43 outputs the acquired TDD information to the control information processing unit 21.

The LB control unit 43 switches the LB unit 22 between the LB off state and the LB on state, based on the acquired TDD information. More specifically, the LB control unit 43 switches the LB unit 22 between the LB off state and the LB on state such that the LB unit 22 is in the LB off state during the uplink transmission period indicated by the TDD information, and the LB unit 22 is in the LB on state during the downlink transmission period indicated by the TDD information.

The LB unit 22, in the LB on state, branches the digital signal DSa received from the LPF 23A into two lines, outputs one branched digital signal DSa to the control information processing unit 21, and outputs the other branched digital signal DSa to the LPF 23B in the filter unit 23. The LB unit 22, in the LB off state, outputs the digital signal DSa received from the LPF 23A to the control information processing unit 21 without branching the same.

The LPF 23B receives the digital signal DSa received from the LB unit 22, and attenuates frequency components equal to or higher than the cutoff frequency fcb in the received digital signal DSa. The LPF 23B outputs, to the multiplexer 26, the digital signal DSa in which the frequency components equal to or higher than the cutoff frequency fcb have been attenuated.

Like the control information processing unit 41 of Modification 1, the control information processing unit 21 may output a digital signal that includes information indicating a timing to start measurement of a processing time PT, for example. In this case, the control information processing unit 21 suspends output of the digital signal during the uplink transmission period indicated by the TDD information, and outputs the digital signal to the LPF 23B during the downlink transmission period indicated by the TDD information. The LPF 23B attenuates frequency components equal to or higher than the cutoff frequency fcb in the digital signal received from the control information processing unit 21, and outputs, to the multiplexer 26, the digital signal in which the frequency components equal to or higher than the cutoff frequency fcb have been attenuated.

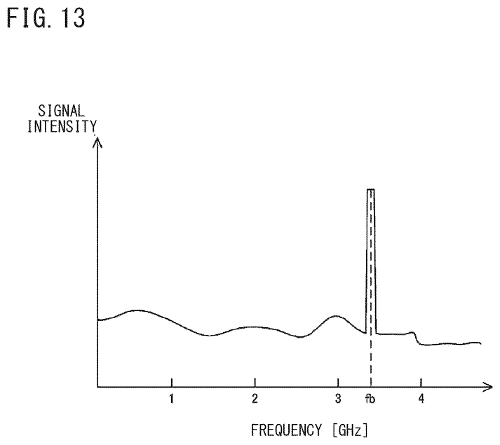

FIG. 13 schematically shows an example of a frequency spectrum of an electric signal that is generated by a multiplexer in a slave station device according to Modification 3 of the first embodiment of the present disclosure. In FIG. 13, the horizontal axis represents frequency [GHz], and the vertical axis represents signal intensity.

With reference to FIG. 13, during the uplink transmission period, the multiplexer 26 does not receive the digital signal DSa from the LPF 23B but receives the IF signal FSb from the frequency converter 24, and outputs the IF signal FSb to the optical modulator 28.

The optical modulator 28 receives the IF signal FSb from the multiplexer 26, and generates an uplink optical signal OPu1 having a wavelength λ2 by optically modulating the received IF signal FSb. During the uplink transmission period, the optical modulator 28 outputs the uplink optical signal OPu1 to the optical fiber 191 via the optical coupler 29.

The master station device 101C may be configured to, during a predetermined period, transmit an uplink optical signal OPd4 which does not include the IF signal FSa but includes the digital signal DSe, to the slave station device 201C via the optical fiber 191.

### Modification 4

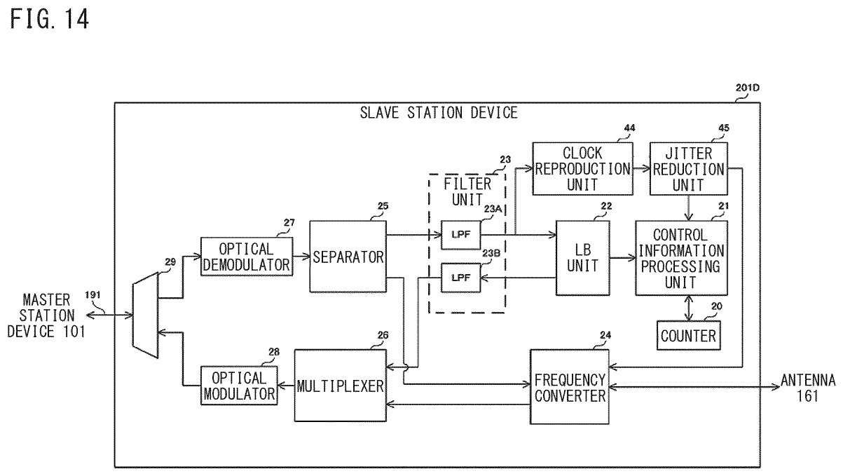

FIG. 14 shows a configuration of a slave station device according to Modification 4 of the first embodiment of the present disclosure. With reference to FIG. 14, a slave station device 201D further includes a clock reproduction unit 44 and a jitter reduction unit 45, as compared to the slave station device 201.

The optical communication system 301 may be configured to include the slave station device 201D instead of the slave station device 201.

The LPF 23A in the slave station device 201D receives the digital signal DSa from the separator 25, and outputs, to the LB unit 22 and the clock reproduction unit 44, the digital signal DSa in which frequency components equal to or higher than the cutoff frequency fca have been attenuated.

The clock reproduction unit 44 receives the digital signal DSa from the LPF 23A, reproduces a local clock CLI in the master station device 101, based on the received digital signal DSa, and outputs the reproduced local clock CLI to the jitter reduction unit 45. For example, the clock reproduction unit 44 includes a high-precision local oscillator, such as a TCXO (Temperature Compensated Crystal Oscillator) or an OCXO (Oven Controlled Crystal Oscillator), having an output signal frequency deviation larger than −10 ppm and smaller than 10 ppm.

The jitter reduction unit 45 receives a local clock CL2 having a frequency f1 from a local clock generator (not shown) in the slave station device 201.

For example, the jitter reduction unit 45 includes a narrow-band PLL (Phase Locked Loop) circuit having a frequency band less than 100 Hz. This PLL circuit may have a multistage configuration. The jitter reduction unit 45 receives the local clock CL1 from the clock reproduction unit 44, performs feedback control using the local clock CLI as a reference signal to synchronize the phase of the local clock CL2 received from the local clock reproduction unit with the reference signal, and outputs the feedback-controlled local clock CL2 to the control information processing unit 21 and the frequency converter 24.

The control information processing unit 21 and the frequency converter 24 are operated based on the local clock CL2 received from the jitter reduction unit 45.

In the optical communication system 301 according to the first embodiment of the present disclosure, the master station device 101 and the slave station device 201 are connected to each other via one optical fiber 191. However, the present disclosure is not limited thereto. The master station device 101 and the slave station device 201 may be connected to each other via two optical fibers 191. In this case, for example, the master station device 101 includes no optical coupler 18. Furthermore, for example, the slave station device 201 includes no optical coupler 29. The optical modulator 16 in the master station device 101 outputs a downlink optical signal to the first optical fiber 191, and the optical demodulator 27 in the slave station device 201 receives the downlink optical signal from the master station device 101 via the first optical fiber 191. The optical modulator 28 in the slave station device 201 outputs an uplink optical signal to the second optical fiber 191, and the optical demodulator 17 in the master station device 101 receives the uplink optical signal from the slave station device 201 via the second optical fiber 191.

In the optical communication system 301 according to the first embodiment of the present disclosure, the master station device 101 generates the digital signal DSa including the TS information, and transmits the downlink optical signal OPd1 including the digital signal DSa and the IF signal FSa to the slave station device 201. However, the present disclosure is not limited thereto. The master station device 101 may be configured to generate a digital signal including no TS information, and transmit a downlink optical signal including the generated digital signal and the IF signal FSa to the slave station device 201. In this case, the slave station device 201 may receive a synchronization signal from an external device (not shown) such as a CU or a GPS, and perform an external synchronization process of synchronizing the count value of the counter 20 with the external device, based on the received synchronization signal.

The master station device 101 according to the first embodiment of the present disclosure includes one frequency converter 13. However, the present disclosure is not limited thereto. The master station device 101 may be configured to include a plurality of frequency converters 13 corresponding to the number of antennae 161 located in different places. In this case, the multiplexer 14 generates an electric signal in which a plurality of IF signals, which are generated by the respective frequency converters 13 and include communication data corresponding to the respective antennae 161, are frequency-multiplexed with the digital signal, and outputs the electric signal to the optical modulator 16.

The master station device 101 according to the first embodiment of the present disclosure may be configured by combining any two or three of the master station devices 101A, 101B, and 101C. The slave station device 201 according to the first embodiment of the present disclosure may be configured by combining any two or three of the slave station devices 201A, 201B, 201C, and 201D.

Meanwhile, a technology capable of realizing a loop-back function between a master station device and a slave station device with a simple configuration, without interrupting communication between the master station device and the slave station device, is desired.

In response to the desire, in the optical communication system 301 according to the first embodiment of the present disclosure, the master station device 101 generates the digital signal DSa including the control information, and transmits the downlink optical signal OPd1 including the generated digital signal DSa and the IF signal FSa to the slave station device 201. The slave station device 201 acquires the digital signal DSa included in the downlink optical signal OPd1 received from the master station device 101, and performs the loop-back process of transmitting the uplink optical signal OPu1 including the acquired digital signal DSa to the master station device 101. The master station device 101 acquires the control information from the digital signal DSa included in the uplink optical signal OPu1 received from the slave station device 201.

As described above, the slave station device 201 acquires the digital signal DSa included in the received downlink optical signal OPd1, and performs the loop-back process of transmitting the uplink optical signal OPu1 including the acquired digital signal DSa to the master station device 101. In this configuration, the digital signal DSa can be transmitted between the master station device 101 and the slave station device 201 while transmitting the IF signal FSa between the master station device and the slave station device. Therefore, the loop-back function can be realized between the master station device 101 and the slave station device 201 with a simple configuration, without interrupting communication between the master station device 101 and the slave station device 201.

For example, in the technology described in PATENT LITERATURE 1, when a delay time between the master station device and the slave station device is measured, the slave station device loops back the main signal, and communication between the master station device and the slave station device is interrupted during the delay time measurement period. The technology described in PATENT LITERATURE 2 is a technology for measuring a delay time between devices, but it is necessary to prepare a system subjected to a synchronization process in advance, which complicates the sequence of the synchronization process.

The technology described in NON-PATENT LITERATURE 1 requires a component such as a framer in an ONU (Optical Network Unit), which complicates the circuit configuration of the ONU. When such a technology is applied to an optical communication system, the circuit configuration of, for example, a slave station device is complicated.

In contrast to the conventional technologies, in the optical communication system 301 according to the first embodiment of the present disclosure, for example, the time information as the control information is looped back between the master station device 101 and the slave station device 201, whereby the transmission delay time DT between the master station device 101 and the slave station device 201 is calculated, and the master station device 101 and the slave station device 201 can be synchronized with each other with a simple configuration, based on the calculated transmission delay time DT.

Furthermore, in the optical communication system 301 according to the first embodiment of the present disclosure, since the optical signal OPd1 including the IF signal FSa and the digital signal DSa is transmitted, the digital signal DSa can be transmitted without the necessity of strictly controlling the frequency of the IF signal FSa. Therefore, the control information can be transmitted more efficiently with a simple configuration.

Moreover, in the optical communication system 301 according to the first embodiment of the present disclosure, the digital signal DSa is branched into two lines by using the LB unit 22, and the loop-back process is performed. In this configuration, the control information can be looped back to the master station device 101 while processing the control information in the slave station device 201.

Next, another embodiment of the present disclosure will be described with reference to the drawings. In the drawings, the same or corresponding parts are denoted by the same reference signs, and description thereof is not repeated.

### Second Embodiment

The second embodiment relates to an optical communication system 302 that transmits a wavelength-multiplexed optical signal via an optical fiber 191, as compared to the optical communication system 301 according to the first embodiment. The optical communication system 302 is identical to the optical communication system 301 of the first embodiment except for the content described below.

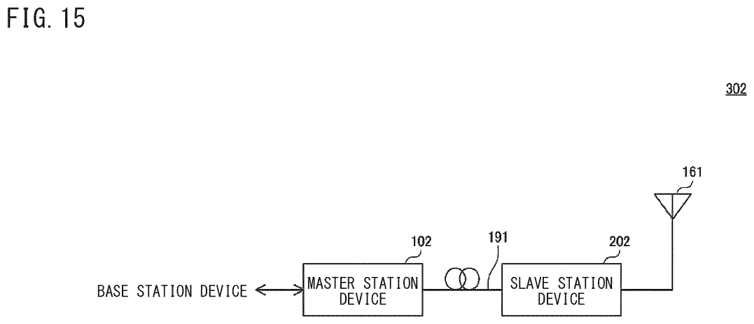

FIG. 15 shows a configuration of an optical communication system according to the second embodiment of the present disclosure. With reference to FIG. 15, the optical communication system 302 includes a master station device 102 instead of the master station device 101, and a slave station device 202 instead of the slave station device 201, as compared to the optical communication system 301 shown in FIG. 1.

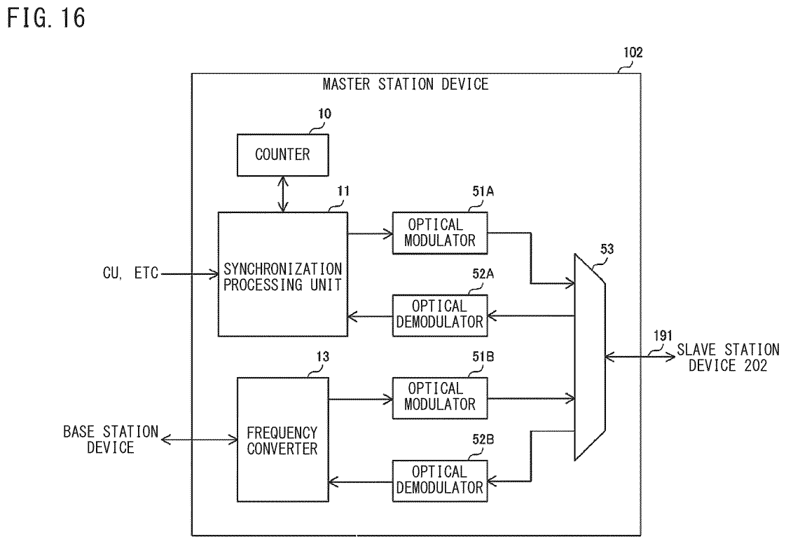

FIG. 16 shows a configuration of a master station device according to the second embodiment of the present disclosure. With reference to FIG. 16, the master station device 102 includes optical modulators 51A, 51B, optical demodulators 52A, 52B, and an optical coupler 53 instead of the filter unit 12, the multiplexer 14, the separator 15, the optical modulator 16, the optical demodulator 17, and the optical coupler 18 of the master station device 101 shown in FIG. 2. The optical coupler 53 is an example of a transmission unit, and an example of a reception unit.

The synchronization processing unit 11 generates an Ethernet frame which is addressed to the slave station device 202 and in which TS information is stored in the payload, and outputs a digital signal DSa including the generated Ethernet frame to the optical modulator 51A.

The optical modulator 51A receives the digital signal DSa from the synchronization processing unit 11, generates a downlink optical signal OPda having a wavelength λ3 by optically modulating the received digital signal DSa, and outputs the generated downlink optical signal OPda to the optical coupler 53.

The frequency converter 13 up-converts or down-convers an analog signal to generate an IF signal FSa, and outputs the generated IF signal FSa to the optical modulator 51B.

The optical modulator 51B receives the IF signal FSa from the frequency converter 13, generates a downlink optical signal OPdb having a wavelength λ4 by optically modulating the received IF signal FSa, and outputs the generated downlink optical signal OPdb to the optical coupler 53.

The optical coupler 53 transmits a downlink optical signal OPdab including the digital signal DSa generated by the synchronization processing unit 11 and the IF signal FSa, to the slave station device 202 via the optical fiber 191.

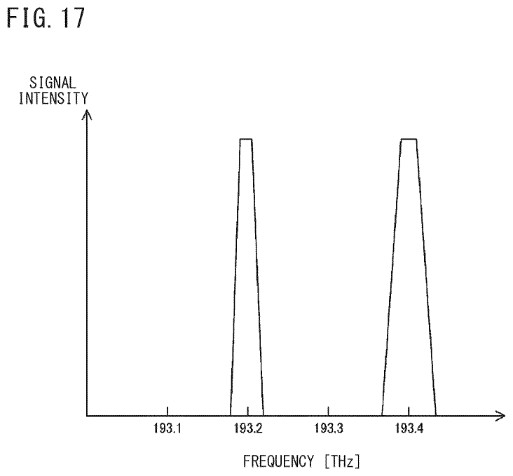

FIG. 17 schematically shows an example of a frequency spectrum of an optical signal outputted from an optical coupler in the master station device according to the second embodiment of the present disclosure. In FIG. 17, the horizontal axis represents frequency [THz], and the vertical axis represents signal intensity.

With reference to FIG. 17, the optical coupler 53 outputs, to the optical fiber 191, a downlink optical signal OPdab in which a downlink optical signal OPda having a wavelength λ3 with a center frequency of 193.4 THz is combined with a downlink optical signal OPdb having a wavelength λ4 with a center frequency of 193.2 THz. That is, the optical coupler 53 wavelength-multiplexes the downlink optical signal OPda and the downlink optical signal OPdb, and outputs a resultant signal to the optical fiber 191.

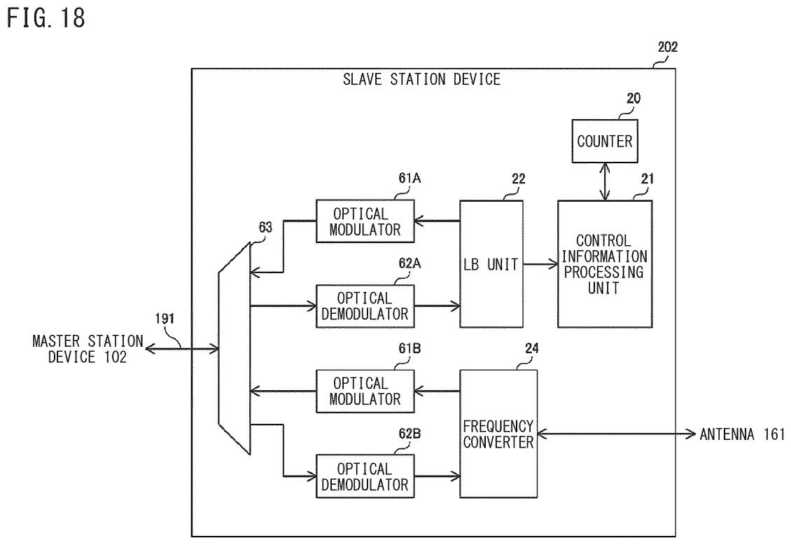

FIG. 18 shows a configuration of a slave station device according to the second embodiment of the present disclosure. With reference to FIG. 18, the slave station device 202 includes optical modulators 61A, 61B, optical demodulators 62A, 62B, and an optical coupler 63 instead of the filter unit 23, the separator 25, the multiplexer 26, the optical demodulator 27, the optical modulator 28, and the optical coupler 29 of the slave station device 201 shown in FIG. 4. The optical coupler 63 is an example of a transmission unit, and an example of a reception unit.

The optical coupler 63 receives the downlink optical signal OPdab from the master station device 102 via the optical fiber 191. The optical coupler 63 separates the received downlink optical signal OPdab according to the wavelength. The optical coupler 63 outputs the downlink optical signal OPda having the wavelength λ3 and the downlink optical signal OPdb having the wavelength λ4, of the received downlink optical signal OPdab, to the optical demodulator 62A and the optical demodulator 62B, respectively.

The optical demodulator 62A acquires the digital signal DSa included in the downlink optical signal OPdab received by the optical coupler 63. More specifically, the optical demodulator 62A generates a digital signal DSa that is an electric signal having a level according to the intensity of the downlink optical signal OPda received from the optical coupler 63, and outputs the generated digital signal DSa to the LB unit 22.

The optical demodulator 62B acquires the IF signal FSa included in the downlink optical signal OPdab received by the optical coupler 63. More specifically, the optical demodulator 62B generates an IF signal FSa that is an electric signal having a level according to the intensity of the downlink optical signal OPdb received from the optical coupler 63, and outputs the generated IF signal FSa to the frequency converter 24.

The LB unit 22 branches the digital signal DSa received from the optical demodulator 62A into two lines. The LB unit 22 outputs one branched digital signal DSa to the control information processing unit 21. The LB unit 22 outputs the other branched digital signal DSa to the optical modulator 61A.

The control information processing unit 21 receives the digital signal DSa from the LB unit 22, and acquires the Ethernet frame from the received digital signal DSa. If the destination MAC address included in the acquired Ethernet frame matches the MAC address of the slave station device 202, the control information processing unit 21 acquires the control information from the payload of the Ethernet frame. The control information processing unit 21 processes the acquired control information.

The frequency converter 24 up-converts the IF signal FSa received from the optical demodulator 62B to generate an RF signal, and outputs the generated RF signal to the antenna 161. Alternatively, the frequency converter 24 down-converts the IF signal FSa received from the optical demodulator 62B to generate a baseband signal, and transmits the generated baseband signal to a device located outside the slave station device 202.

The frequency converter 24 receives an OFDM-modulated analog signal including communication data from the mobile communication terminal (not shown) via the antenna 161. The frequency converter 24 may be configured to receive, as an analog signal, an RF signal from the mobile communication terminal (not shown) via the antenna 161, or a baseband signal via wires. The frequency converter 24 up-converts or down-converts the received analog signal to generate an IF signal FSb, and outputs the generated IF signal FSb to the optical modulator 61B.

The optical modulator 61A receives the digital signal DSa from the LB unit 22, generates an uplink optical signal OPua having a wavelength λ5 by optically modulating the received digital signal DSa, and outputs the generated uplink optical signal OPua to the optical coupler 63.

The optical modulator 51B receives the IF signal FSb from the frequency converter 24, generates an uplink optical signal OPub having a λ6 by optically modulating the received IF signal FSb, and outputs the generated uplink optical signal OPub to the optical coupler 63.

The optical coupler 63 transmits an uplink optical signal OPuab including the digital signal DSa acquired by the optical demodulator 62A to the master station device 102 via the optical fiber 191. More specifically, the optical coupler 63 outputs, to the optical fiber 191, the uplink optical signal OPuab in which the uplink optical signal OPua having the wavelength λ5 and the uplink optical signal OPub having the wavelength λ6 are combined. That is, the optical coupler 63 wavelength-multiplexes the uplink optical signal OPua and the uplink optical signal OPub, and outputs a resultant signal to the optical fiber 191.

Referring back to FIG. 16, the optical coupler 53 in the master station device 101 receives the uplink optical signal OPuab including the digital signal DSa that the slave station device 202 has acquired from the downlink optical signal OPda, from the slave station device 202 via the optical fiber 191. The optical coupler 53 separates the received uplink optical signal OPuab according to the wavelength. The optical coupler 53 outputs the uplink optical signal OPua having the wavelength λ5 and the uplink optical signal OPub having the wavelength λ6, of the received uplink optical signal OPuab, to the optical demodulator 52A and the optical demodulator 52B, respectively.

The optical demodulator 52A generates a digital signal DSa that is an electric signal having a level according to the intensity of the uplink optical signal OPua received from the optical coupler 53, and outputs the generated digital signal DSa to the synchronization processing unit 11.

The optical demodulator 52B generates an IF signal FSb that is an electric signal having a level according to the intensity of the uplink optical signal OPub received from the optical coupler 53, and outputs the generated IF signal FSb to the frequency converter 13.

For example, the frequency converter 13 up-converts the IF signal FSb received from the optical demodulator 52B to generate an RF signal, and outputs the generated RF signal to the base station device. Alternatively, the frequency converter 13 down-converts the IF signal FSb received from the optical demodulator 52B to generate a baseband signal, and transmits the generated baseband signal to the base station device.

The synchronization processing unit 11 acquires the TS information from the digital signal DSa included in the uplink optical signal OPuab received by the optical coupler 53. More specifically, the synchronization processing unit 11 receives the digital signal DSa from the optical demodulator 52A, and acquires the Ethernet frame from the received digital signal DSa. The synchronization processing unit 11 acquires the TS information from the payload of the Ethernet frame. Then, the synchronization processing unit 11 calculates the transmission delay time DT, and generates synchronization information including the synchronization time ST1.

The synchronization processing unit 11 transmits the generated synchronization information to the slave station device 202. More specifically, the synchronization processing unit 11 outputs, to the optical modulator 51A, the digital signal DSb including the Ethernet frame which is addressed to the slave station device 202 and in which the synchronization information is stored in the payload.

The optical modulator 51A receives the digital signal DSb from the synchronization processing unit 11, generates a downlink optical signal OPdc having a wavelength λ3 by optically modulating the received digital signal DSb, and outputs the generated downlink optical signal OPdc to the optical coupler 53.

The optical coupler 53 outputs, to the optical fiber 191, a downlink optical signal OPdcb in which the downlink optical signal OPdc having the wavelength λ3 and the downlink optical signal OPdb having the wavelength λ4 are combined.

Referring back to FIG. 18, the optical coupler 63 separates the received downlink optical signal OPdeb according to the wavelength. The optical coupler 63 outputs the downlink optical signal OPdc having the wavelength λ3 and the downlink optical signal OPdb having the wavelength λ4, of the received downlink optical signal OPdcb, to the optical demodulator 62A and the optical demodulator 62B, respectively.

The optical demodulator 62A generates a digital signal DSb that is an electric signal having a level according to the intensity of the downlink optical signal OPdc received from the optical coupler 63, and outputs the generated digital signal DSb to the LB unit 22.

The LB unit 22 branches the digital signal DSb received from the optical demodulator 62A into two lines. The LB unit 22 outputs one branched digital signal DSb to the control information processing unit 21. The LB unit 22 outputs the other branched digital signal DSb to the optical modulator 61A.

The control information processing unit 21 receives the digital signal DSb from the LB unit 22, and acquires the Ethernet frame from the received digital signal DSb. If the destination MAC address included in the acquired Ethernet frame matches the MAC address of the slave station device 202, the control information processing unit 21 acquires the synchronization information from the payload of the Ethernet frame. Upon acquiring the synchronization information, the control information processing unit 21 updates the count value of the counter 20, based on the acquired synchronization information. That is, the control information processing unit 21 sets the count value of the counter 20 to the synchronization time ST1 included in the synchronization information.

### Modification 1

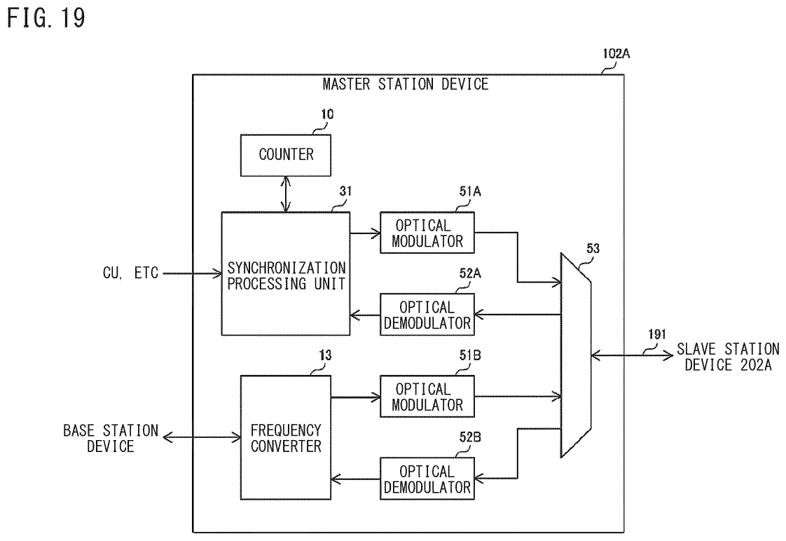

FIG. 19 shows a configuration of a master station device according to Modification 1 of the second embodiment of the present disclosure. With reference to FIG. 19, a master station device 102A includes a synchronization processing unit 31 instead of the synchronization processing unit 11 of the master station device 102.

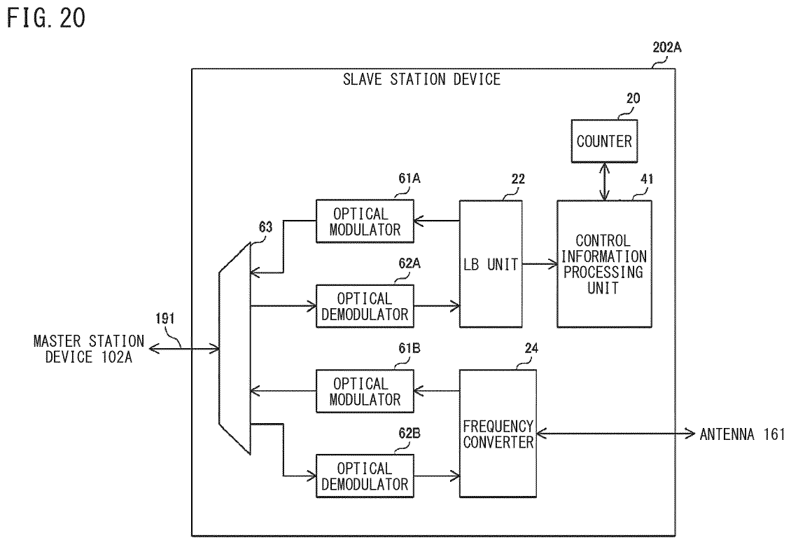

FIG. 20 shows a configuration of a slave station device according to Modification 1 of the second embodiment of the present disclosure. With reference to FIG. 20, the slave station device 202A includes a control information processing unit 41 instead of the control information processing unit 21 of the slave station device 202.

The optical communication system 302 may be configured to include a master station device 102A and a slave station device 202A instead of the master station device 102 and the slave station device 202. The slave station device 202A generates a digital signal DSc that includes processing time information indicating a processing time PT required for processing control information, and transmits an uplink optical signal including the generated digital signal DSc to the master station device 102A via the optical fiber 191. The digital signal DSc is an example of a fourth digital signal. The master station device 102A acquires the processing time information from the uplink optical signal received from the slave station device 202A. The master station device 102A sets a synchronization time ST2 based on the processing time PT indicated by the acquired processing time information, and transmits synchronization information indicating the set synchronization time ST2 to the slave station device 201A. The slave station device 202A receives the synchronization information from the master station device 102A, and updates the count value of the counter 20, based on the received synchronization information.

The details of the operation and processing of the synchronization processing unit 31 and the details of the operation and processing of the control information processing unit 41 are the same as those described in Modification 1 of the first embodiment.

### Modification 2

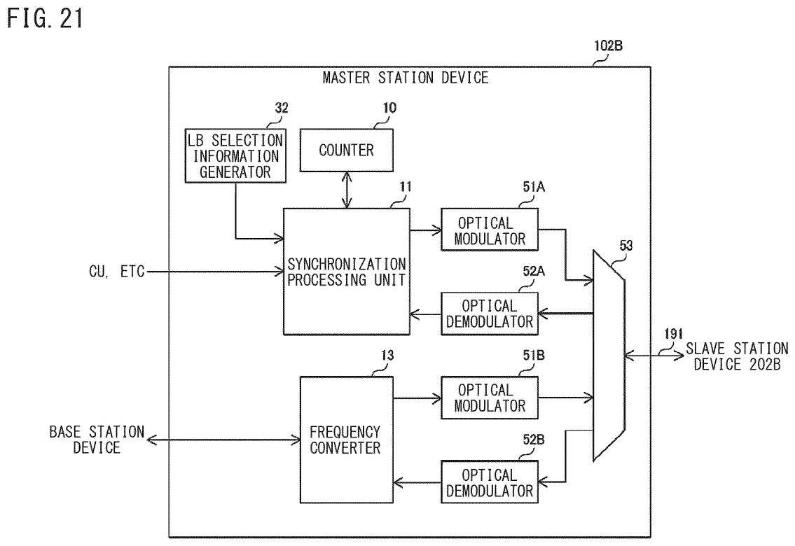

FIG. 21 shows a configuration of a master station device according to Modification 2 of the second embodiment of the present disclosure. With reference to FIG. 21, the master station device 102B further includes an LB selection information generator 32, as compared to the master station device 102.

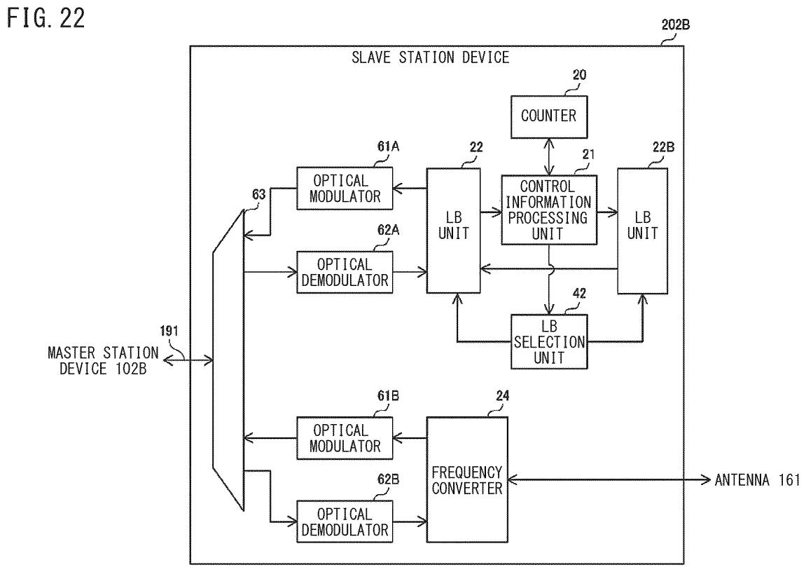

FIG. 22 shows a configuration of a slave station device according to Modification 2 of the second embodiment of the present disclosure. With reference to FIG. 22, a slave station device 202B includes LB units 22A, 22B as the LB unit 22 and further includes an LB selection unit 42, as compared to the slave station device 202.

The optical communication system 302 may be configured to include a master station device 102B and a slave station device 202B instead of the master station device 102 and the slave station device 202. In the loop-back process, the slave station device 202B can transmit, to the master station device 102A, an uplink optical signal including a digital signal DSa looped back at a plurality of different positions in the transmission path inside the slave station device 202A. The master station device 102A generates a digital signal including LB selection information indicating the positions at which the digital signal DSa is to be looped back, and transmits a downlink optical signal including the digital signal to the slave station device 202B.

The details of the operation and processing of the LB selection information generator 32, the details of the operation and processing of the LB unit 22, and the details of the operation and processing of the LB selection unit 42 are the same as those described in Modification 2 of the first embodiment.

### Modification 3

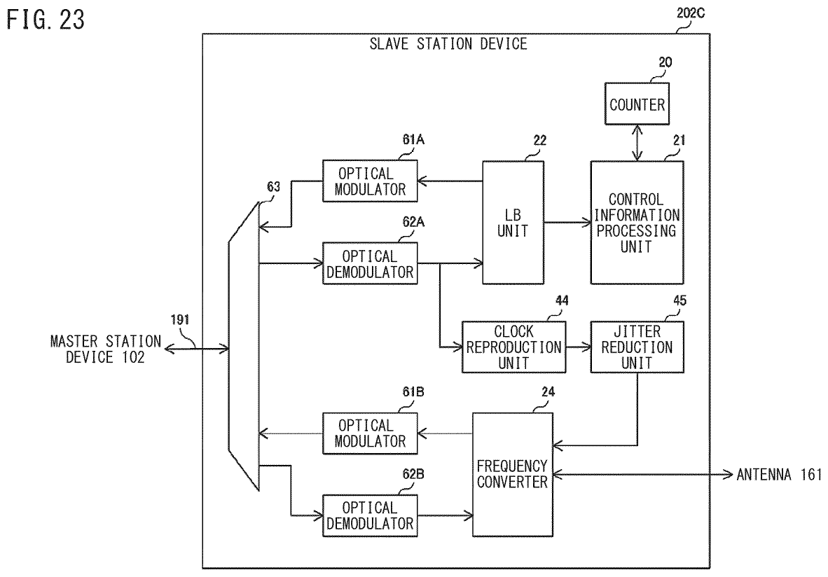

FIG. 23 shows a configuration of a slave station device according to Modification 3 of the second embodiment of the present disclosure. With reference to FIG. 23, a slave station device 201C further includes a clock reproduction unit 44 and a jitter reduction unit 45, as compared to the slave station device 201.

The optical communication system 302 may be configured to include the slave station device 201C instead of the slave station device 202.

The details of the operation and processing of the clock reproduction unit 44 and the jitter reduction unit 45 are the same as those described in Modification 4 of the first embodiment.

In the optical communication system 302 according to the second embodiment of the present disclosure, influences of the digital signal DSa on the IF signal FSa can be inhibited, and transmission quality of the IF signal FSa can be improved, as compared to the configuration in which the digital signal DSa and the IF signal FSa are frequency-multiplexed.

The above embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

The processes (functions) of the above-described embodiments may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

The above description includes the features in the additional note below.

### Additional Note 1

An optical communication system including:
a master station device; and
a slave station device, wherein
the master station device generates a first digital signal including control information, and transmits, to the slave station device, a downlink optical signal including the generated first digital signal and an analog main signal,
the slave station device acquires the first digital signal included in the downlink optical signal received from the master station device, and performs a loop-back process of transmitting an uplink optical signal including the acquired first digital signal to the master station device,
the master station device acquires the control information from the first digital signal included in the uplink optical signal received from the slave station device, and
the master station device generates the first digital signal including time information as the control information, acquires the time information from the first digital signal included in the received uplink optical signal, and calculates an RTT of the time information, based on the acquired time information.

### REFERENCE SIGNS LIST

10 counter
11, 31 synchronization processing unit
12 filter unit
12A, 12B LPF
13 frequency converter
14 multiplexer
15 separator
16 optical modulator
17 optical demodulator
18 optical coupler
20 counter
21, 41 control information processing unit
22, 22A, 22B LB unit
23 filter unit
23A, 23B LPF
24 frequency converter
25 separator
26 multiplexer
27 optical demodulator
28 optical modulator
29 optical coupler
32 LB selection information generator
33 TDD information acquisition unit
42 LB selection unit
43 LB control unit
44 clock reproduction unit
45 jitter reduction unit
51A, 51B optical modulator
52A, 52B optical demodulator
53 optical coupler
61A, 61B optical modulator
62A, 62B optical demodulator
63 optical coupler
101, 101A, 101B, 101C, 102, 102A, 101B master station device
191 optical fiber
201, 201A, 201B, 201C, 201D, 202, 202A, 202B, 202C slave station device
301, 302 optical communication system

1. An optical communication system comprising:
a master station device; and
a slave station device, wherein
the master station device generates a first digital signal including control information, and transmits, to the slave station device, a downlink optical signal including the generated first digital signal and an analog main signal,
the slave station device acquires the first digital signal included in the downlink optical signal received from the master station device, and performs a loop-back process of transmitting an uplink optical signal including the acquired first digital signal to the master station device, and
the master station device acquires the control information from the first digital signal included in the uplink optical signal received from the slave station device.

2. The optical communication system according to claim 1, wherein the master station device generates the first digital signal including time information as the control information, acquires the time information from the first digital signal included in the received uplink optical signal, and performs a synchronization process with the slave station device, based on the acquired time information.

3. The optical communication system according to claim 1, wherein
the master station device generates a second digital signal including information indicating a timing at which the slave station device performs the loop-back process, and further transmits a downlink optical signal including the generated second digital signal to the slave station device.

4. The optical communication system according to claim 1, wherein
in the loop-back process, the slave station device is able to loop back the first digital signal at a plurality of different positions in a transmission path inside the slave station device to transmit the first digital signal to the master station device, and
the master station device generates a third digital signal including positional information indicating positions at which the first digital signal is to be looped back, and further transmits a downlink optical signal including the generated third digital signal to the slave station device.

5. The optical communication system according to claim 1, wherein
the slave station device acquires the control information from the first digital signal, generates a fourth digital signal that includes processing time information indicating a processing time required for processing the acquired control information, and further transmits an uplink optical signal including the generated fourth digital signal to the master station device.

6. The optical communication system according to claim 1, wherein
in the loop-back process, the slave station device branches the acquired first digital signal, and transmits an uplink optical signal including the branched first digital signal to the master station device.

7. A master station device comprising:
a generation unit configured to generate a first digital signal including control information;
a transmission unit configured to transmit, to another device, a downlink optical signal including the first digital signal generated by the generation unit, and an analog main signal;
a reception unit configured to receive, from the other device, an uplink optical signal including the first digital signal that the other device has acquired from the downlink optical signal; and
an acquisition unit configured to acquire the control information from the first digital signal included in the uplink optical signal received by the reception unit.

8. A slave station device comprising:
a reception unit configured to receive, from another device, a downlink optical signal that includes a first digital signal including control information, and an analog main signal;
an acquisition unit configured to acquire the first digital signal included in the downlink optical signal received by the reception unit; and
a transmission unit configured to transmit, to the other device, an uplink optical signal including the first digital signal acquired by the acquisition unit.

9. An optical communication method in an optical communication system including a master station device and a slave station device, the method comprising:
by the master station device, generating a first digital signal including control information, and transmitting a downlink optical signal including the generated first digital signal and an analog main signal to the slave station device;
by the slave station device, acquiring the first digital signal included in the downlink optical signal received from the master station device, and performing a loop-back process of transmitting an uplink optical signal including the acquired first digital signal to the master station device; and
by the master station device, acquiring the control information from the first digital signal included in the uplink optical signal received from the slave station device.
